(19) United States
(12) Patent Application Publication
(10) Pub. No.: US 2004/0225610 A1
(43) Pub. Date: Nov. 11, 2004

(54) Method and system for performing preference analysis

(76) Inventor: Michael L. Newsom, Safety Harbor, FL (US)

Correspondence Address: James J. DeCarlo, Stroock & Stroock & Lavan LLP, 180 Maiden Lane, New York, NY, 10038, US

(21) Appl. No.: 10/841,285

(22) Filed: May 6, 2004

Related U.S. Application Data
(60) Provisional application No. 60/468,480, filed on May 6, 2003.

(51) Int. Cl. G06F 17/60

(52) U.S. Cl. 705/40

(57) ABSTRACT

Methods and systems for performing preference analysis, and, more particularly, methods and systems for performing preference analysis, are described. Certain embodiments of the invention include a system for performing preference analysis, operable in connection with software to receive preference period payment data relating to one or more invoice payments from a debtor to a creditor made during a predetermined preference period; analyze said preference period invoice payment data in accordance with predetermined ordinary course parameters to determine whether one or more of said invoice payments falls within or outside a universe of invoice payments made in the ordinary course of business; analyze said preference period invoice payment data in accordance with predetermined new value parameters to determine whether an amount of one or more or a portion of an amount of one or more invoice payments determined to fall outside of said universe of invoice payments made in the ordinary course of business was made in exchange for new value provided by said creditor to said debtor, wherein an amount of one or more of or a portion of an amount of said invoice payments falling outside said universe of invoice payments made in the ordinary course of business and determined not to be made in exchange for new value is determined to be a potentially voidable preference payment amount; and create a record of said potentially voidable preference payment amount.

### CROSS-REFERENCE TO RELATED APPLICATIONS

This Application claims the benefit of U.S. Provisional Application Serial No. 60/468,480, filed on May 6, 2003, entitled METHOD AND SYSTEM FOR PERFORMING PREFERENCE ANALYSIS.

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

1. Field of the Invention

The present invention relates generally to performing preference analysis, and more particularly to methods and systems for performing preference analysis.

2. Description of Related Art

Bankruptcy is a legal process whereby the debts of an insolvent person or company are liquidated after being satisfied to the greatest extent possible by the debtor's assets. When a debtor declares for bankruptcy, creditors of the debtor must generally wait in line to collect the debt that is owed to them, the order of which is determined by the nature of the obligation giving rise to the debt. Prior to a bankruptcy filing, the debtor and certain creditors might have knowledge of an impending bankruptcy and attempt to unjustly distribute the assets of the debtor, without regard for a more equitable collection procedure that might be established at a formal bankruptcy proceeding. In order to discourage such favoritism toward certain creditors prior to the filing of a bankruptcy claim, certain laws provide that any transfer made for the benefit of the creditor, on the account of antecedent debt, while the debtor was insolvent (sometimes called the “preference period”, for example 90 days prior to bankruptcy filing) that allows the creditor to receive more than such creditor would otherwise receive, is considered a “preference”. A bankruptcy trustee or other administrator or government entity may order a creditor to surrender such a preference payment, so that the assets may be distributed to creditors in proper succession, by what is referred to as “preference avoidance”. However, certain legal provisions hold that an avoidance may not be claimed where the transfer from the debtor to the creditor was either (1) an exchange for new value; or (2) made in the ordinary course of business.

A key obstacle to objectifying ordinary course is the lack of a standard practice for the measurement of behavior, i.e. the measurement of payment performance. Statistical analysis is not commonly recognized as a measurement technique in performing preference analysis. Most ordinary course of business analyses are performed in terms of averages and spans. However, averages and spans tell little about actual changes. Accordingly, a need exists for a method and system for improved analyzing of statistical data to perform preference analysis.

### SUMMARY OF THE INVENTION

According to certain embodiments, methods and systems for performing preference analysis are disclosed.

One embodiment of the invention is directed to a system for performing preference analysis. The system of this embodiment is operable in connection with software to receive preference period payment data relating to one or more invoice payments from a debtor to a creditor made during a predetermined preference period; analyze said preference period invoice payment data in accordance with predetermined ordinary course parameters to determine whether one or more of said invoice payments falls within or outside a universe of invoice payments made in the ordinary course of business; analyze said preference period invoice payment data in accordance with predetermined new value parameters to determine whether an amount of one or more or a portion of an amount of one or more invoice payments determined to fall outside of said universe of invoice payments made in the ordinary course of business was made in exchange for new value provided by said creditor to said debtor, wherein an amount of one or more of or a portion of an amount of said invoice payments falling outside said universe of invoice payments made in the ordinary course of business and determined not to be made in exchange for new value is determined to be a potentially voidable preference payment amount; and create a record of said potentially voidable preference payment amount.

Another embodiment of the invention is directed to a system for performing preference analysis. The system in this embodiment is operable in connection with software to receive preference period invoice payment data relating to one or more invoice payments from a debtor to a creditor made during a predetermined preference period; receive pre-preference period invoice payment data for one or more invoices, said pre-preference period invoice payment data comprising an invoice payment amount and a respective invoice age, said pre-preference period invoice payment data relating to one or more invoice payments from said debtor to said creditor made during a predetermined pre-preference period; determine ordinary course parameters by analyzing said pre-preference period invoice payment data, wherein said ordinary course parameters comprise an invoice age range comprising an upper invoice age limit and a lower invoice age limit, said invoice age range determined by: calculating a total representing a denominator sum of the amounts of said invoice payments at all invoice ages for a predetermined number of said payments made during said pre-preference period; grouping one or more of said invoice ages into a plurality of invoice age increments and calculating a numerator sum of the amounts of said invoice payments at one or more of said invoice age increments; and dividing said numerator sum by said denominator so as to determine a percent of completion at one or more of said invoice age increments; analyze said preference period invoice payment data to determine whether an invoice age of one or more of said payments made during said preference period is within or outside of said invoice age range, and wherein one or more of said invoice payments made during said preference period must have an invoice age outside said invoice age range to be considered to fall outside a universe of payments made in the ordinary course of business and be considered a potentially voidable preference payment; and create a record of said potentially voidable preference payment.

Yet another embodiment of the invention is directed to a system for performing preference analysis. The system in this embodiment is operable in connection with software to receive preference period payment data relating to one or more invoice payments from a debtor to a creditor made during a predetermined preference period; analyze said preference period invoice payment data in accordance with predetermined ordinary course parameters to determine whether one or more of said invoice payments falls within or outside a universe of invoice payments made in the ordinary course of business; analyze said preference period invoice payment data in accordance with predetermined new value parameters to determine whether an amount of one or more or a portion of an amount of said invoice payments was made in exchange for new value provided by said creditor to said debtor; wherein an amount of one or more or a portion of an amount of one or more of said invoice payments falling outside said universe of invoice payments made in the ordinary course of business and determined not to be made in exchange for new value is determined to be a potentially voidable preference payment amount; and create a record of said potentially voidable preference payment amount.

Yet another embodiment of the invention is directed to a method for performing preference analysis. The method in this embodiment comprises: receiving preference period payment data relating to one or more invoice payments from a debtor to a creditor made during a predetermined preference period; analyzing said preference period invoice payment data in accordance with predetermined ordinary course parameters to determine whether one or more of said invoice payments falls within or outside a universe of invoice payments made in the ordinary course of business; analyzing said preference period invoice payment data in accordance with predetermined new value parameters to determine whether an amount of one or more or a portion of an amount of one or more of invoice payments determined to fall outside of said universe of invoice payments made in the ordinary course of business was made in exchange for new value provided by said creditor to said debtor, wherein an amount of one or more or a portion of an amount of one or more of said invoice payments falling outside said universe of invoice payments made in the ordinary course of business and determined not to be made in exchange for new value is determined to be a potentially voidable preference payment amount; and creating a record of said potentially voidable preference payment amount.

Yet another embodiment of the invention is directed to a method for performing preference analysis. The method in this embodiment comprises: receiving preference period invoice payment data relating to one or more invoice payments from a debtor to a creditor made during a predetermined preference period; receiving pre-preference period invoice payment data for one or more invoices, said pre-preference period invoice payment data comprising an invoice payment amount and a respective invoice age, said pre-preference period invoice payment data relating to one or more invoice payments from said debtor to said creditor made during a predetermined pre-preference period; determining ordinary course parameters by analyzing said pre-preference period invoice payment data, wherein said ordinary course parameters comprise an invoice age range comprising an upper invoice age limit and a lower invoice age limit, said invoice age range determined by: calculating a total representing a denominator sum of the amounts of said invoice payments at all invoice ages for a predetermined number of said payments made during said pre-preference period; grouping one or more of said invoice ages into a plurality of invoice age increments and calculating a numerator sum of the amounts of said invoice payments at one or more of said invoice age increments; and dividing said numerator sum by said denominator so as to determine a percent of completion at one or more of said invoice age increments; analyzing said preference period invoice payment data to determine whether an invoice age of one or more of said payments made during said preference period is within or outside of said invoice age range, and wherein one or more of said invoice payments made during said preference period must have an invoice age outside said invoice age range to be considered to fall outside a universe of payments made in the ordinary course of business and be considered a potentially voidable preference payment; and creating a record of said potentially voidable preference payment.

Yet another embodiment of the invention is directed to a method for performing preference analysis. The method in this embodiment comprises: receiving preference period payment data relating to one or more invoice payments from a debtor to a creditor made during a predetermined preference period; analyzing said preference period invoice payment data in accordance with predetermined ordinary course parameters to determine whether one or more of said invoice payments falls within or outside a universe of invoice payments made in the ordinary course of business; analyzing said preference period invoice payment data in accordance with predetermined new value parameters to determine whether an amount of one or more or a portion of an amount of one or more of said invoice payments was made in exchange for new value provided by said creditor to said debtor, wherein an amount of one or more or a portion of an amount of one or more of said invoice payments falling outside said universe of invoice payments made in the ordinary course of business and determined not to be made in exchange for new value is determined to be a potentially voidable preference payment amount; and creating a record of said potentially voidable preference payment amount.

Other embodiments and features are further described herein. The invention will next be described in connection with certain exemplary, non-limiting embodiments; however, it should be clear to those skilled in the art and from the teachings herein that various modifications, additions, and subtractions can be made without departing from the spirit or scope of the claims, which set forth the scope of the invention.

### BRIEF DESCRIPTION OF THE DRAWINGS

The following drawing figures, in which like reference numerals refer to like components, and which are included herewith and form a part of this application, are intended to be illustrative examples and not limiting of the scope of the present invention.

FIG. 1 is an exemplary percent of completion table according to one embodiment of the present invention.

FIG. 2 is an exemplary percent of completion graph according to one embodiment of the present invention.

FIG. 3 is a flowchart illustrating the steps of calculation or generation of tabular invoice payment records according to one embodiment of the present invention.

FIG. 4 is an exemplary invoice payment table according to one embodiment of the present invention.

FIG. 5 is a flowchart illustrating the steps of calculation or generation of tabular monetary transfer records according to one embodiment of the present invention.

FIG. 6 is an exemplary monetary transfer table according to one embodiment of the present invention.

FIG. 7 is a flowchart illustrating the steps of calculation or data processing for the generation of tables and graphs according to one embodiment of the present invention.

FIG. 8 is an exemplary distribution table of dollars paid according to one embodiment of the present invention.

FIG. 9 is an exemplary distribution chart of dollars paid according to one embodiment of the present invention.

FIG. 10 is a further exemplary percent of completion table according to one embodiment of the present invention.

FIG. 11 is a further exemplary percent of completion graph according to one embodiment of the present invention.

FIG. 12 is a flowchart illustrating the steps of graphical determination of the ordinary course brackets according to this embodiment of the present invention.

FIG. 13 is a flowchart illustrating the steps of calculation of ordinary course transactions according to this embodiment of the present invention.

FIG. 14 is a flowchart illustrating the steps of calculation of the amount preference payments in accordance with new value analysis for invoice payments falling outside the ordinary course of business according to this embodiment of the present invention.

FIGS. 15a-15d illustrate an exemplary new value report according to one embodiment of the present invention.

FIG. 16 is a box diagram illustrating the system components according to one embodiment of the present invention.

FIG. 17 is an exemplary new value table according to one embodiment of the present invention.

FIGS. 18-20 are exemplary screen shots of a graphical user interface according to one embodiment of the present invention.

### DETAILED DESCRIPTION OF CERTAIN EMBODIMENTS

In general, the methods and systems described herein enable the performing of bankruptcy preference analysis to determine whether certain transactions made by an insolvent party (the “debtor”), prior to filing for bankruptcy, are considered preference payments that can be voided. One method of performing preference analysis is to apply ordinary course of business analysis. Under ordinary course of business analysis, payments made by a debtor to a creditor during the preference period are examined to determine whether such payments were within the ordinary course of business. Where such payments are determined to have been made outside the ordinary course of business, such payments are considered to be potentially voidable preferences.

Another method of performing preference analysis is to apply new value analysis. Under new value analysis, payments made by a debtor to a creditor during the preference period are examined to determine whether such payments or the amounts of such payment, including portions of the amounts of such payments, were made by the debtor in return for new value provided by the creditor. Where the payments or amounts of such payments are not determined to have been made by the debtor in return for new value provided by the creditor, such payments are considered potentially voidable preference payments or voidable preference payment amounts. It may be desirable to combine ordinary course of business analysis with new value analysis, in order to determine whether a payment made by the debtor to the creditor during the preference period may be considered to be a voidable preference payment or whether the amount of, or a portion of the amount of, a payment made by the debtor to the creditor during the preference period may be considered to be a voidable preference payment amount.

Once a voidable preference payment or voidable preference payment amount is determined, a record of the voidable preference payment or voidable preference payment amount may be created manually or electronically or in a user perceptible form or format, such as by non-limiting example: displaying on a screen, recording on paper, storing on storage media, or storing on or as part of a database or data record or data table.

One method of performing ordinary course of business analysis is to utilize percent of completion analysis. A percent of completion analysis involves determining payment performance over a period of time, by calculating the percentage of the total amount of payments that have been made at multiple increments during the period of time. In one embodiment, a percent of completion analysis may be used to objectively determine whether a payment made by a debtor to a creditor during a preference period of time was made outside the ordinary course of business, and thus a potentially voidable preference payment.

To perform the percent of completion analysis in this embodiment, a debtor's payment performance is calculated over a period of time prior to the preference period (the “pre-preference period”). Based on the debtor's pre-preference period payment performance, certain criteria is established to determine whether a debtor's payment was “made in the ordinary course of business.” Payments made by the debtor during the preference period are then evaluated based on the criteria to determine whether such payments are considered to be made outside the ordinary course of business and thus potentially voidable preference payments.

In the exemplary embodiments described herein, the starting and ending dates of the pre-preference period may be selected by the person desirous of performing the analysis. In the exemplary embodiments described herein, the preference period is considered to be the 90 day period prior to the formal filing of bankruptcy by the debtor. However, in alternative embodiments, the preference period may be greater or less than this number of days, depending upon the period of time desired by the user. Further, it is to be understood that the steps in the following embodiments are exemplary and may be performed in any suitable order, combined into fewer steps or divided into more steps.

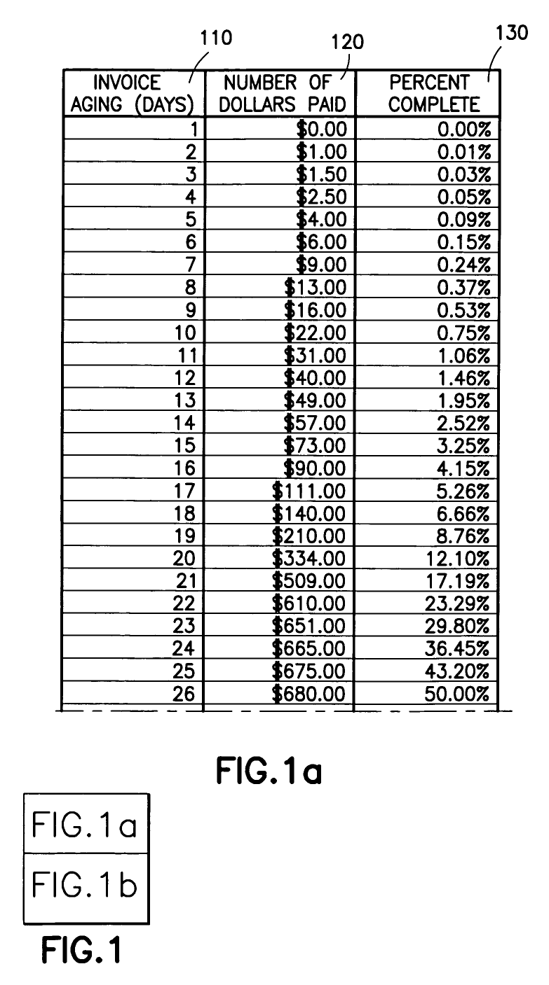

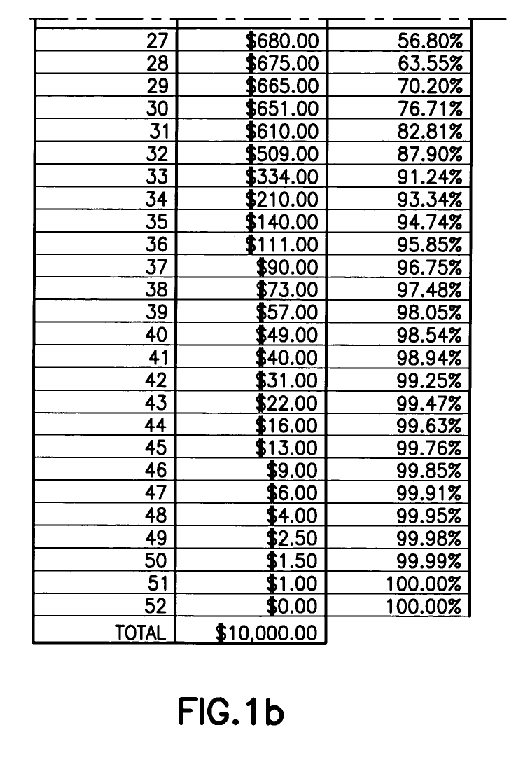

In one exemplary embodiment, as shown in FIG. 1, certain payment and invoice data is used to a create a percent of completion table to show a debtor's payment performance prior to the preference period. Such data may include, but is not limited to the following: debtor and creditor names, ID numbers, invoice numbers, invoice dates, invoice amounts, payment numbers, payment types, payment dates, payment clear dates, and payment amounts. Such data may be gathered from, but is not limited to the following: dispersing agents, account numbers, bank statements, proofs of transfer, in house records and memos, balance statements, internal documents and forecasts, external financial evaluations, and names and contact information of individuals responsible for company financial strategy and analysis. Such payment data may be tabulated manually or extracted from a payment database or other electronic storage medium via methods known in the art.

The invoice age represents a passage of time between the beginning and ending dates of a payment period. In this exemplary embodiment, the invoice age is defined as the number of days that passed between issuance of an invoice and the payment of the invoice. Referring again to FIG. 1, day numbers are listed in the first column entitled Invoice Aging 110 which represent the potential invoice ages of the payments made by the debtor during the pre-preference period. This table represents a tabular representation of data from sources such as those examples set forth in the prior paragraph and as further set forth herein. The choice of how many days should be listed in the Invoice Aging column 110 may be determined by the person performing the preference analysis. In this example, as illustrated in FIG. 1, days 1 through 52 were chosen to be displayed in the Invoice Aging column 110.

In accordance with the present embodiment, each payment made by the debtor during the selected pre-preference period is examined to determine the invoice age of each invoice being paid. Referring again to FIG. 1, the invoice age for each payment is tabulated and listed in the Invoice Aging column 110 and the amount of the payment is listed in the corresponding row of the second column entitled Number of Dollars Paid 120. A running total of the payment amounts for each invoice age is kept for each row of the Number of Dollars Paid column 120, since there may be multiple payment amounts at the same invoice age. For example, as shown in the table in FIG. 1, the total amount of the payments made by the debtor at an invoice age of 25 days was $675.00. While dollars are generally referred to in the embodiments described herein, any monetary system may be used to reflect the payment of invoices described herein.

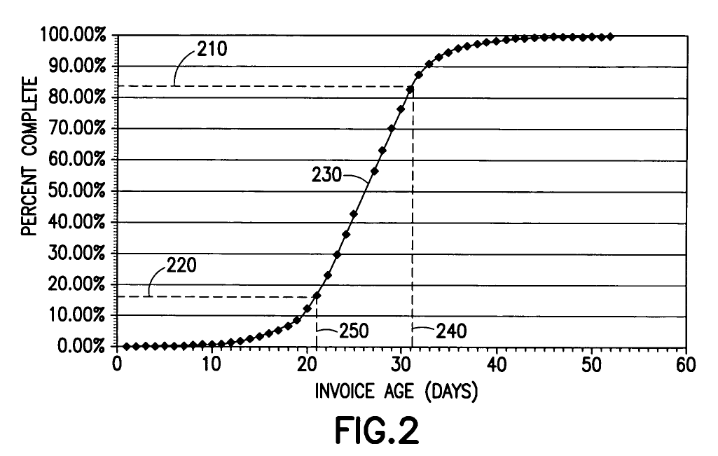

The percent of the total payments made during the selected pre-preference period (referred to as the “percent of completion”) is calculated at each invoice age, and is tabulated and listed in the corresponding row of the third column entitled Percent Complete 130. The percent of completion for each invoice age is calculated by dividing the total amount of the payments at the chosen invoice age by the total amount of the payments by the debtor at all invoice ages (determined by adding the amount in each row of the Number of Dollars column 120). For example, as shown in FIG. 1, to calculate the percent of completion at an invoice age of 25 days, the Number of Dollars Paid at 25 days, $675.00, would be divided by the total number of dollars paid, $10,000.00. Therefore, in this example, the percent of completion at an invoice age of 25 days would be 43.20%. A percent of completion graph, representing the debtor's payment performance during the pre-preference period may be produced by graphing the Percent Complete (Y-axis) versus the Invoice Age (X-axis) to show the percent of completion plot 230, as shown in FIG. 2.

Having determined the debtor's payment performance during the pre-preference period, in this embodiment it is next determined what portion of the debtor's pre-preference period payments should be considered to be made in the ordinary course of business. In this manner, certain criteria may be established that are common to all pre-preference period payments considered to be made in the ordinary course of business. This criteria may then be used to evaluate whether a payment made during the preference period should be considered to be made in the ordinary course of business.

The portion of the debtor's pre-preference period payments to be considered, or the portion determined to be made in the ordinary course of business may be an objective or subjective determination made by the person or entity performing the analysis, and may vary depending upon certain factors particular to the preference analysis, including, but not limited to, the parties involved in the preference analysis, the particular industry involved in the preference analysis, the position of the person or entity performing the analysis, or the requirements under the law of the relevant jurisdiction or venue. Additionally, the portion of the debtor's pre-preference period payments considered to be made in the ordinary course of business may be determined prior to or following determination of the debtor's pre-preference payment performance. The portion can be varied and several analyses using different assumptions can also be carried for comparison purposes, for example.

In one exemplary embodiment, the portion of the debtor's pre-preference period payments considered to be made in the ordinary course of business is defined as a percentage of the total number of dollars paid by the debtor during the pre-preference period. Based on the percentage assigned as “ordinary”, lower and upper brackets (referred to as “ordinary course brackets”) may be used to establish criteria that is common to all pre-preference period payments considered to be made in the ordinary course of business. The ordinary course brackets in this embodiment establish such criteria based on the invoice age at which payments were made by the debtor.

In this exemplary embodiment, the percent of completion graph in FIG. 2 is used to better visualize the determination of the ordinary course brackets. In this example, 68 percent of the total number of dollars paid by the debtor during the pre-preference period, extending along a range centered at the 50% point, is assigned as made in the ordinary course of business; however, in alternate embodiments, a larger or smaller percentage may be selected and that percentage is not limited to a centered percentage range, but can start at any point along the percentage complete axis as a matter of choice by the analyst or user. In the described embodiment shown in FIG. 2, the upper percent complete limit would occur at 84% and the lower percent complete limit would occur at 16%. To determine the upper ordinary course bracket limit, a horizontal line 210 is drawn from the upper percent complete limit on the vertical axis, i.e. 84%, to the intersection point of the percent of completion plot 230, and then a vertical line 240 is drawn from the intersection point of the plot 230 down to the horizontal axis representing Invoice Age in days (as illustrated by the dotted lines in FIG. 2). The upper ordinary course bracket limit is the Invoice Age day value as obtained or extracted at the point on the horizontal limit intersected by the vertical line 240, or 31 days in this example. To determine the lower ordinary course bracket limit, a horizontal line 220 is drawn from the lower percent complete limit on the vertical axis, i.e. 16%, to the intersection point of the percent of completion plot 230, and then a vertical line 250 is drawn from the intersection point of the plot 230 down to the horizontal axis (as illustrated by the dotted lines in FIG. 2). The lower ordinary course bracket limit, defined by line 250, is the number of days beyond this invoice age on the horizontal axis (the invoice age plus one), or 21 days in this example. Therefore, as illustrated in FIG. 2 by the dotted lines, the ordinary course brackets are determined to define an invoice age range of 21-31 days.

Once the defined invoice age range is determined, the debtor's payments during the preference period are then each evaluated to determine whether each such payment falls within the range defined by the ordinary course brackets. Where a payment made by the debtor during the preference period falls within the ordinary course brackets, the payment is determined to be made in the ordinary course of business and therefore not considered a potentially voidable preference payment. Where a payment made by the debtor during the preference period falls outside of the ordinary course brackets, the payment is determined to be made outside the ordinary course of business and therefore considered a potentially voidable preference payment. In this example, a payment made by the debtor during the preference period would be considered made in the ordinary course of business only where such payment is made between 21 and 31 days from the invoice date. Where such payment was not made between 21 and 31 days from the invoice date, the payment would be considered a potentially voidable preference payment for the purposes of this example.

In certain embodiments, ordinary course of business analysis may be combined with new value analysis, in order to determine whether a payment made by the debtor to the creditor during the preference period may be considered to be a voidable preference payment.

In one such embodiment, new value analysis is applied to payments made by the debtor to a creditor during the preference period that are considered to have been made outside the ordinary course of business to further determine whether such payments are voidable preference payments. In this embodiment, the new value provided by the creditor for each day of the preference period is determined by examining only those invoices issued by the creditor subsequent to the payment of antecedent debt by the debtor during the preference period.

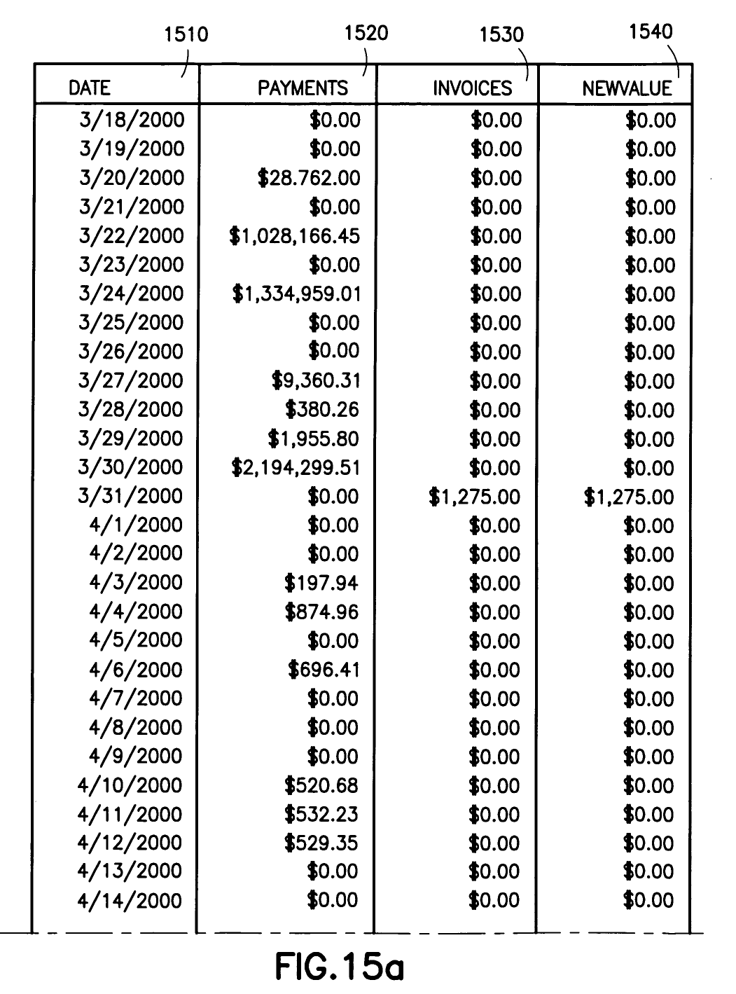

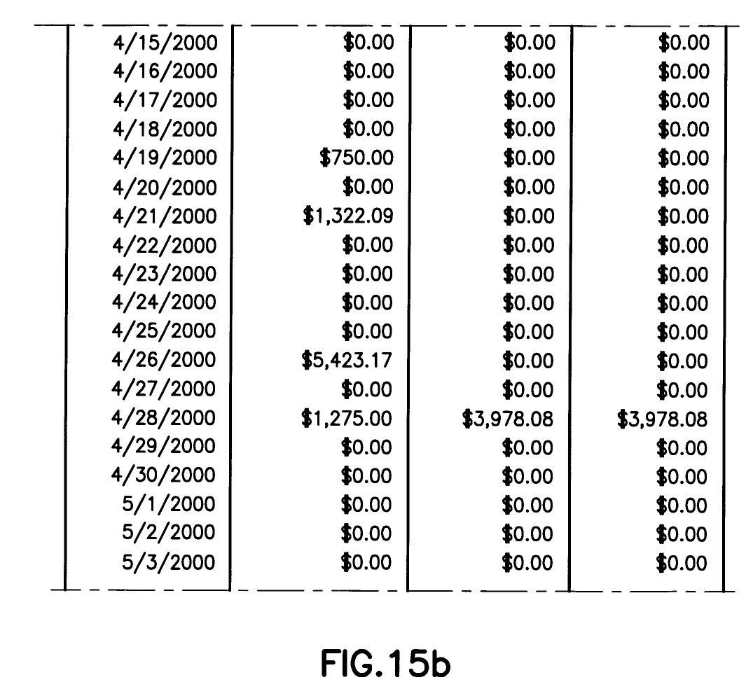

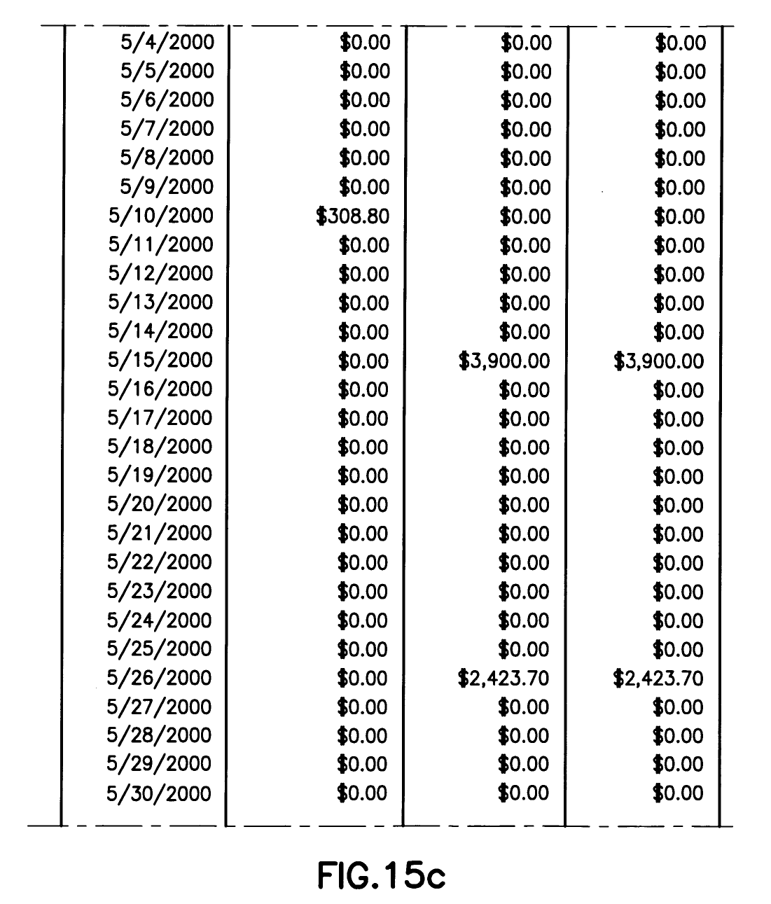

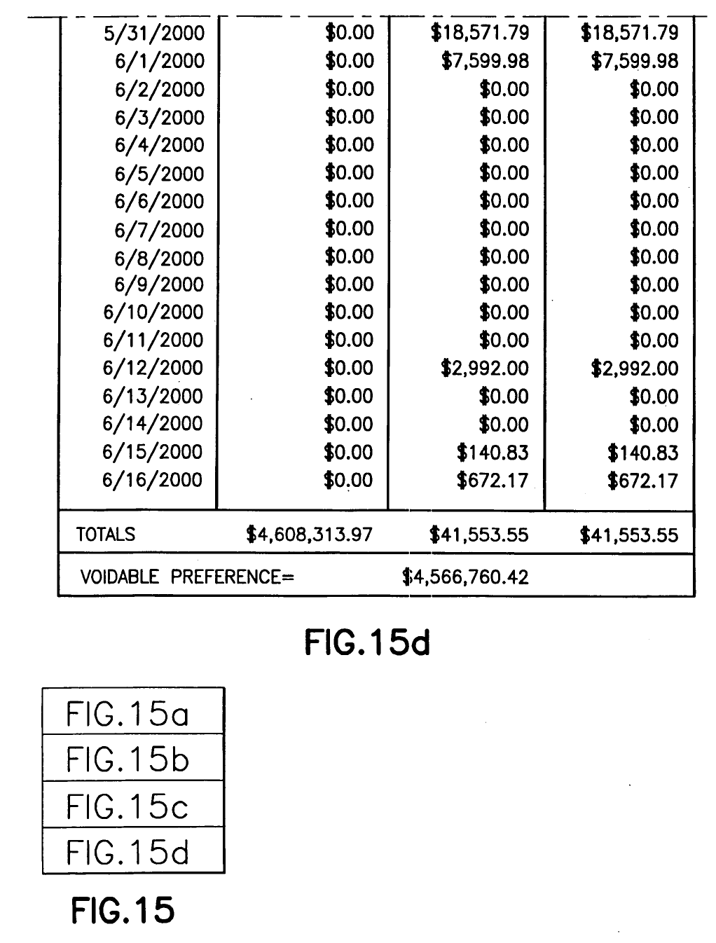

An exemplary new value report is shown in FIGS. 15a through 15d to illustrate performing a new value analysis according to one exemplary embodiment. Initially, each day of the preference period is listed in the first column entitled Date 1510. The total amount of payments made by the debtor to the creditor for each day of the preference period is listed in the corresponding row of the second column entitled Payments 1520. The dollar total of all invoiced amounts as invoiced by the creditor to the debtor, for each day of the preference period, are listed in the corresponding row of the third column entitled Invoices 1530.

The amount of new value provided by the creditor on each day of the preference period is listed in the corresponding row of the fourth column entitled New Value 1540. As stated above, in this embodiment, the new value provided by the creditor for each day of the preference period is determined by examining only those invoices issued by the creditor after the payment of antecedent debt by the debtor during the preference period. The amount of new value provided by the creditor on a given day of the preference period is determined by applying the following formula:

If the total invoice amount for a given day is less than (the sum of the amount of all payments up to and including that given day minus the sum of the amount of all new value up to and including the day before), then the amount of new value provided by the creditor for that day is the total amount of the invoice for the given day.

If the total invoice amount for a given day is greater than (the sum of the amount of all payments up to and including that given day minus the sum of the amount of all new value up to and including the day before), then the amount of new value provided by the creditor for that day is the amount in parenthesis.

The total preference payment amount for the preference period may be determined by subtracting the total new value amount provided by the creditor for the preference period from the total amount of payments by the debtor for the preference period.

For example, referencing FIGS. 15a through 15d, the following steps can be used to determine the amount of new value provided by the creditor on Apr. 28, 2000: The sum of the amount of all payments up to and including Apr. 28, 2000 is equal to $4,608,005.17. The sum of the amount of all new value up to and including Apr. 27, 2000 is equal to $1,275.00. Therefore, the sum of the amount of all payments up to and including Apr. 28, 2000 minus the sum of the amount of all new value up to and including Apr. 27, 2000 is equal to $4,606,730.17. The total invoice amount for Apr. 28, 2000, namely $3,978.08, is less than $4,606,730.17, so the amount of new value provided by the creditor for Apr. 28, 2000 is the total amount of the invoice for Apr. 28, 2000, $3,978.08.

Additionally, with continuing reference to FIGS. 15a through 15d, the total preference payment amount for the preference period of Mar. 18, 2000-Jun. 16, 2000 may be determined by subtracting the total new value amount provided by the creditor for the preference period, i.e. $41,553.55, from the total amount of payments by the debtor for the preference period, i.e. $4,608,313.97, which is equal to $4,566,760.42.

A further exemplary embodiment of the present invention will now be described with reference to the aforementioned figures. The system of this embodiment enables a user of the system to enter manually, or import from a storage medium, certain data related to the financial transactions of one or more debtors and one or more creditors, such as data relating to the issuance and payments of invoices. This data may be processed to determine whether certain payments made by the debtor during the preference period are considered preferences that can potentially be voided. The system enables a user to determine whether certain payments made by the debtor during the preference period were made in the ordinary course of business, such as by performing percent of completion analysis. The system also enables a user to determine whether certain payments made by the debtor during the preference period were made by the debtor in return for new value provided by the creditor. In this manner, the user may determine whether such payments made by the debtor during the preference period are preference payments or amounts of preference payments that can potentially be voided.

The system and method enables the user to combine ordinary course of business analysis with new value analysis; however such a combination is not necessary to performing preference analysis. Additionally, the system enables a user to generate a variety of different reports and charts that can be accessed by the user for a variety of purposes, including but not limited to, recordkeeping, presentations, legal analysis, or enhancing preference analysis through visual representation.

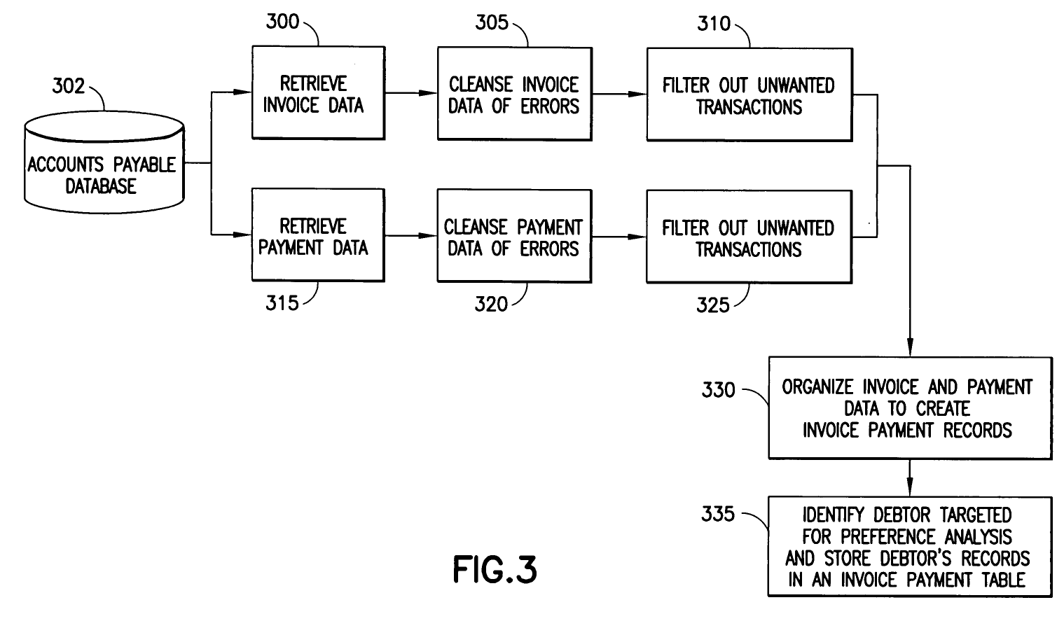

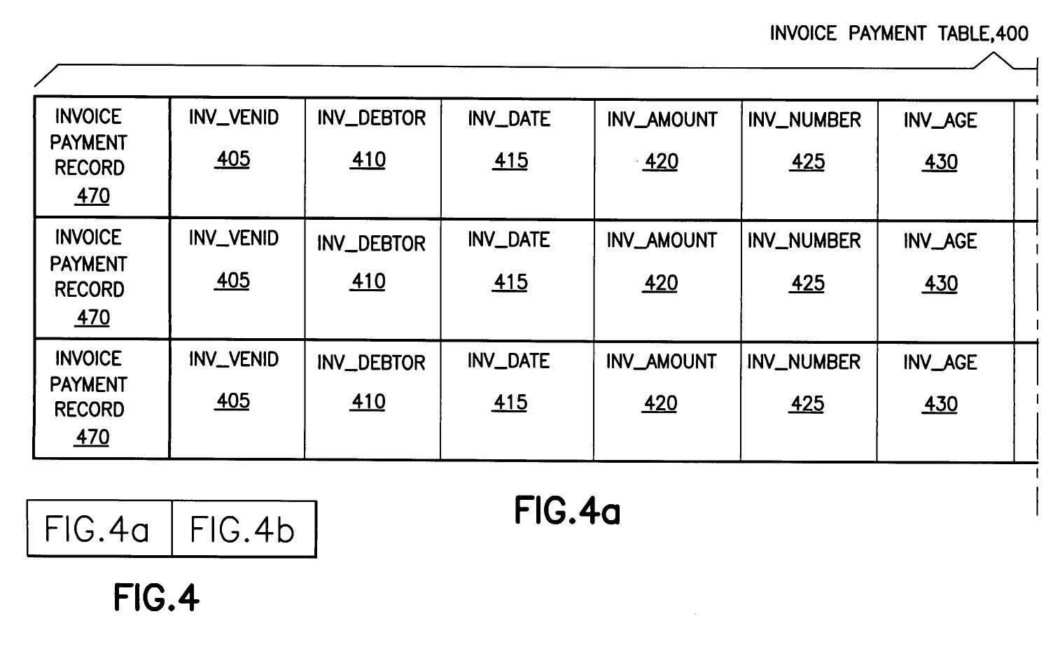

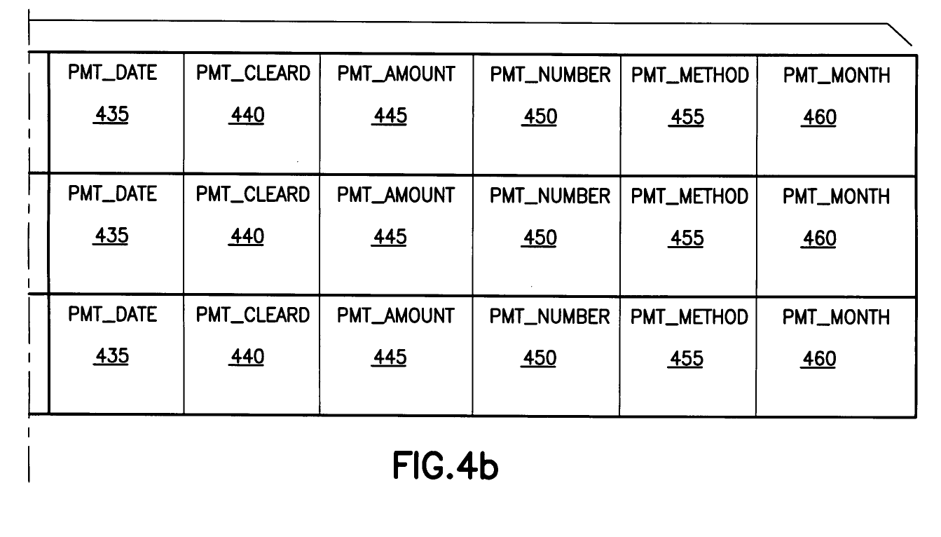

FIG. 3 is a flowchart illustrating the steps of calculation or generation of tabular invoice payment records 470 (FIG. 4) according to this embodiment of the present invention.

In step 300, transaction data relating to invoices, such as invoice numbers, invoice dates, and invoice amounts, is retrieved from a data storage medium, such as an accounts payable database 302 of a type known in the art. In step 305, this invoice data is cleansed of any errors, such as for example simple typographical errors in the invoice data, double entry of the same invoice data and the like. In step 310, unwanted transactions, such as for example non-cash credit and discounts, credit or debit memos for discounts or reversals of discounts, surcharges or product returns and the like, are filtered out of the invoice data. Similarly, in step 315, transaction data relating to payments, such as payment numbers, payment dates, and payment amounts, is retrieved from a data storage medium, such as the above-referenced accounts payable database. In step 320, this payment data is cleansed of any errors, such as for example typographical errors in the payment data, double entry of the same payment data, and the like. In step 325, unwanted transactions, such as for example non cash credit and discounts, are filtered out of the payment data. In step 330, the invoice data and payment data are organized to create invoice payment records 470 in an invoice payment table 400. As shown in FIG. 4, each invoice payment record 470 preferably contains the following data fields.

The field “inv_venid” 405 represents the debtor number.

The field “inv_debtor” 410 represents the invoice debtor name.

The field “inv_date” 415 represents the invoice date in mm/dd/yyyy format.

The field “inv_amount” 420 represents the invoice amount.

The field “inv_number” 425 represents the invoice number.

The field “inv_age” 430 represents the invoice age (the number of days that passed between issuance of each invoice and payment of the invoice)

The field “pmt_date” 435 represents the payment date in mm/dd/yyyy format.

The field “pmt_cleard” 440 represents the payment cleared date in mm/dd/yyyy format.

The field “pmt_amount” 445 represents the payment amount.

The field “pmt_number” 450 represents the payment number.

The field “pmt_method” 455 represents the payment method e.g. check, wire.

The field “pmt_month” 460 represents the payment month from 1-18 counting backward.

In step 335, the invoice payment records 470 for a debtor targeted for preference analysis are identified and stored in an invoice payment table 400 created for such debtor. A separate invoice payment table 400 is preferably created for each debtor targeted for preference analysis. In this exemplary embodiment, each invoice payment table 400 contains approximately two years of invoice and payment data for the debtor. The one or more invoice payment tables 400 may be stored in or on any storage medium that is capable of being in communication with the system and the time period of invoices analyzed may be varied as a matter of design choices.

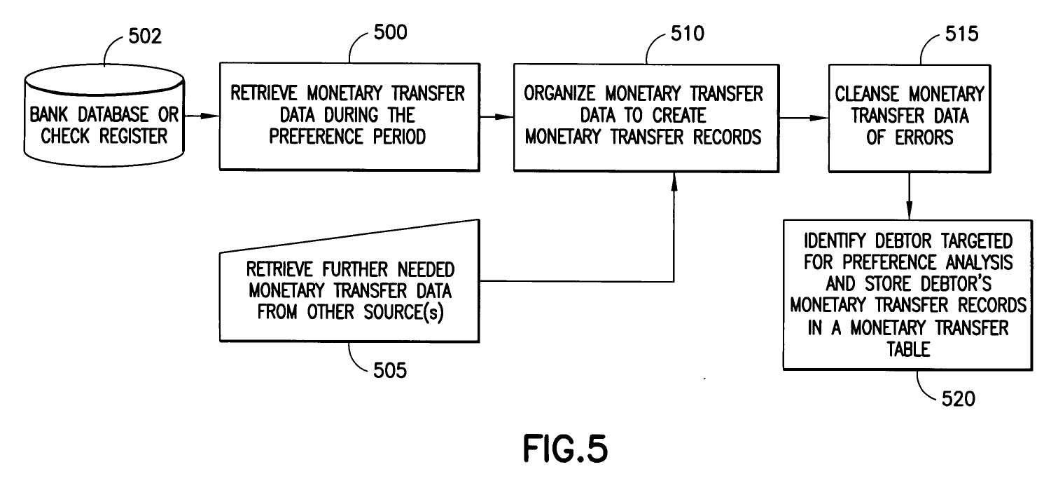

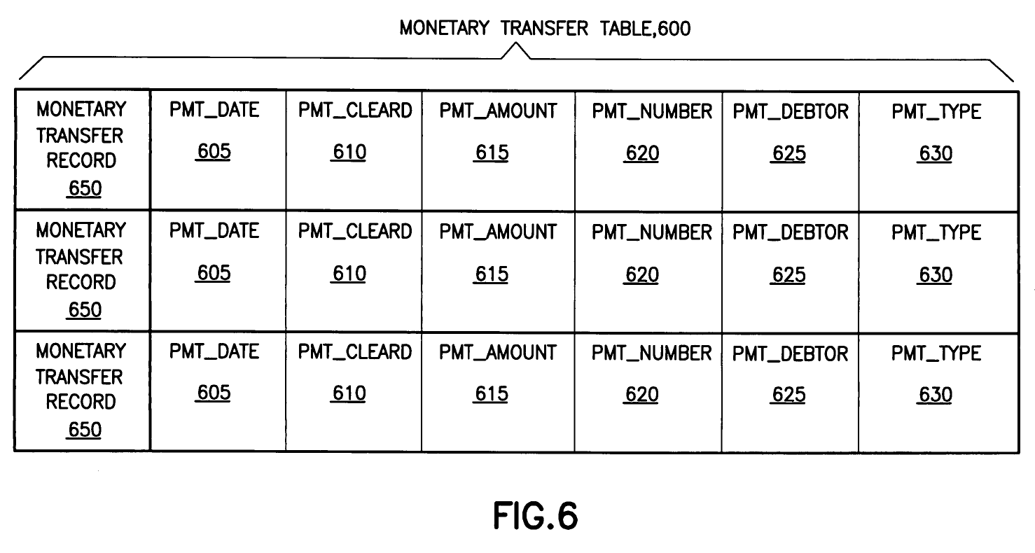

FIG. 5 is a flowchart illustrating the steps of calculation or generation of tabular monetary transfer data records (FIG. 6) according to one embodiment of the present invention.

In step 500, data relating to monetary transfers made during the preference period are retrieved from a data storage medium, such as a bank database or check register 502 of a type known in the art or other known sources. This monetary transfer data may include, but is not limited to information regarding checks, wires, and other cash or monetary transfers made during the preference period. The data storage medium selected to retrieve this monetary transfer data may generally be determined by reviewing the invoice and payment data stored in the invoice payment records 470. In step 505, any further monetary transfer data deemed desirable for analysis, such as check clearing dates or other confirmed transaction dates, may be retrieved from any other available known source of such data. In step 510, the retrieved monetary transfer data is organized to create monetary transfer records 650. As shown in FIG. 6, each monetary transfer record preferably contains the following data fields.

The field “pmt_date” 605 represents the payment date in mm/dd/yyyy format.

The field “pmt_cleard” 610 represents the payment cleared date in mm/dd/yyyy format.

The field “pmt_amount” 615 represents the payment amount.

The field “pmt_number” 620 represents the payment number.

The field “pmt_debtor” 625 represents the payment debtor name.

The field “pmt_type” 630 represents the payment type, such as check or wire.

Referring again to FIG. 5, in step 515 the data contained in the monetary transfer records 650 is cleansed of any errors, such as for example typographical errors, double entries of the same data, and the like. In step 520, the monetary transfer records 650 for a debtor targeted for preference analysis are identified and stored in a monetary transfer table 600 created for such debtor. A separate monetary transfer table 600 is preferably created for each debtor targeted for preference analysis. The one or more monetary transfer tables 600 can be stored in or on any storage medium that is capable of being in communication with or passed to the system or method utilized to carry out the herein described steps, which may be performed manually, or be automated, or some combination thereof.

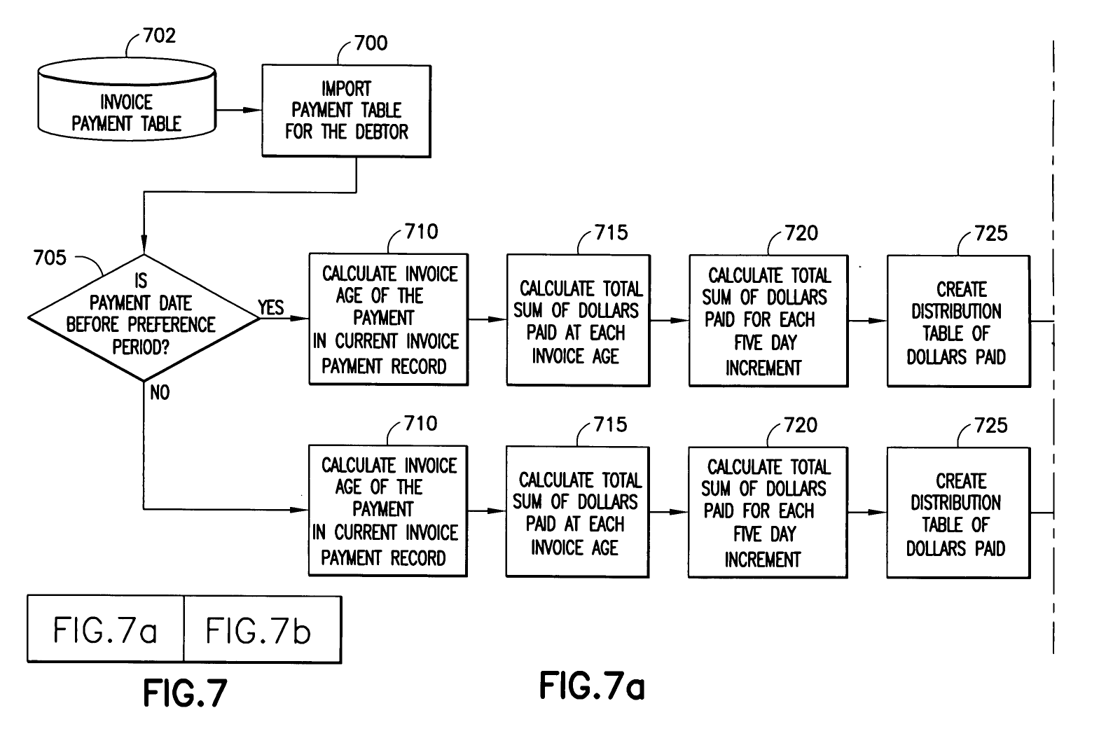

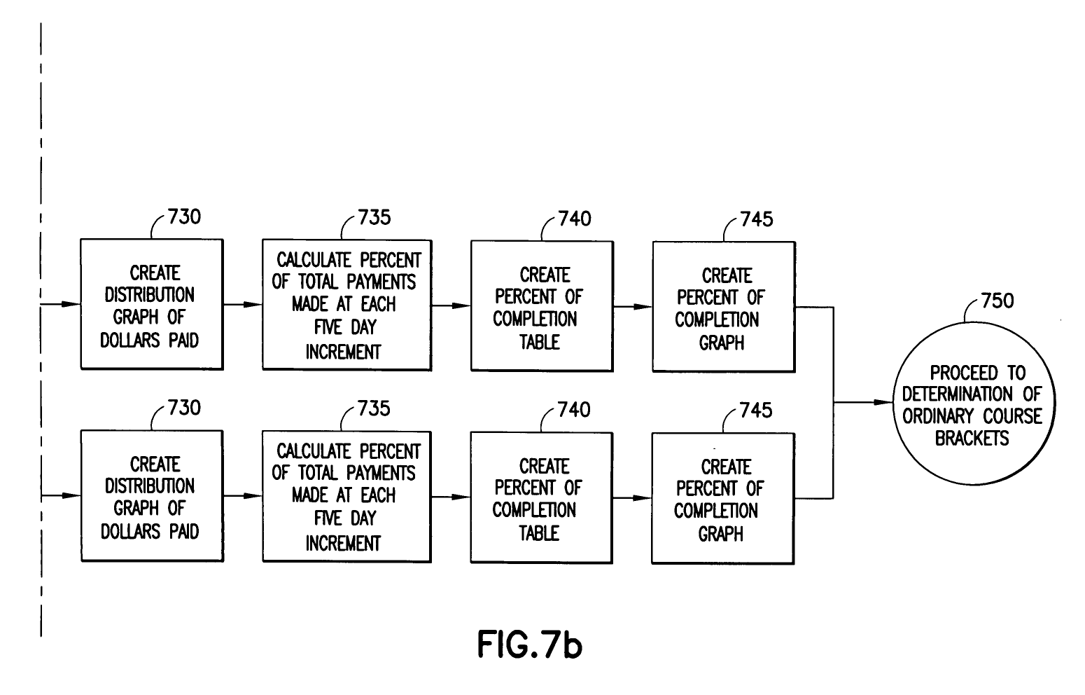

FIG. 7 is a flowchart illustrating the steps of calculation or data processing for the generation of tables and graphs according to one embodiment of the present invention. The data stored for a debtor in an invoice payment table 400 may be analyzed and manipulated to create a series of tables and graphs in order to use percent of completion analysis to compare a debtor's payment performance during the preference period with the debtor's payment performance prior to the preference period.

In step 700, an invoice payment table 400 for a debtor is imported into the system in a known manner or is manually tabulated. In step 705, each invoice payment record 470 in the debtor's invoice payment table 400 is examined to determine whether the payment date, as stored in the pmt_date field 435 of the invoice payment record 470, occurred prior to the preference period. Where it is determined, in step 705, that the payment date occurred prior to the preference period, the data in the current invoice payment record 470 is applied to determine pre-preference period payment performance. In step 710, the invoice age of the payment in the current invoice payment record 470 is determined by calculating the number of days that passed between the date of issuance of the invoice, as stored in the inv_date field 415 of the current invoice payment record 470, and the later date of either the date of payment of the invoice, as stored in the pmt_date field 435 of the current invoice payment record 470, or the date on which the payment of the invoice cleared, as stored in the pmt_cleared field 440 of the current invoice payment record 470. In this exemplary embodiment, where the date on which the payment cleared is not available, the system and method described defaults to use the payment date of the invoice. The resultant invoice age of the payment is then stored in the inv_age field 415 of the current invoice payment record 470. In step 715, the total amount of dollars paid at each invoice age is determined by creating a temporary counter variable for each invoice age and then adding the amount of the payment (stored in the pmt_amount field 445) of the current invoice payment record 470 to the proper counter variable depending upon the invoice age for the payment, as stored in the inv_age field 415 of the current invoice payment record 470. In step 720, the invoice ages are broken into five day invoice age increments and the total sum of dollars paid for each five day invoice age increment is calculated by adding the amounts stored in the counter variables for each invoice age in that five day increment.

Referring again to FIGS. 7 and 4, if it is determined, in step 705, that the payment date occurred during the preference period, the data in the current invoice payment record 470 is applied to determine preference period payment performance, by performing the same calculations as described in above in connection with steps 710-720.

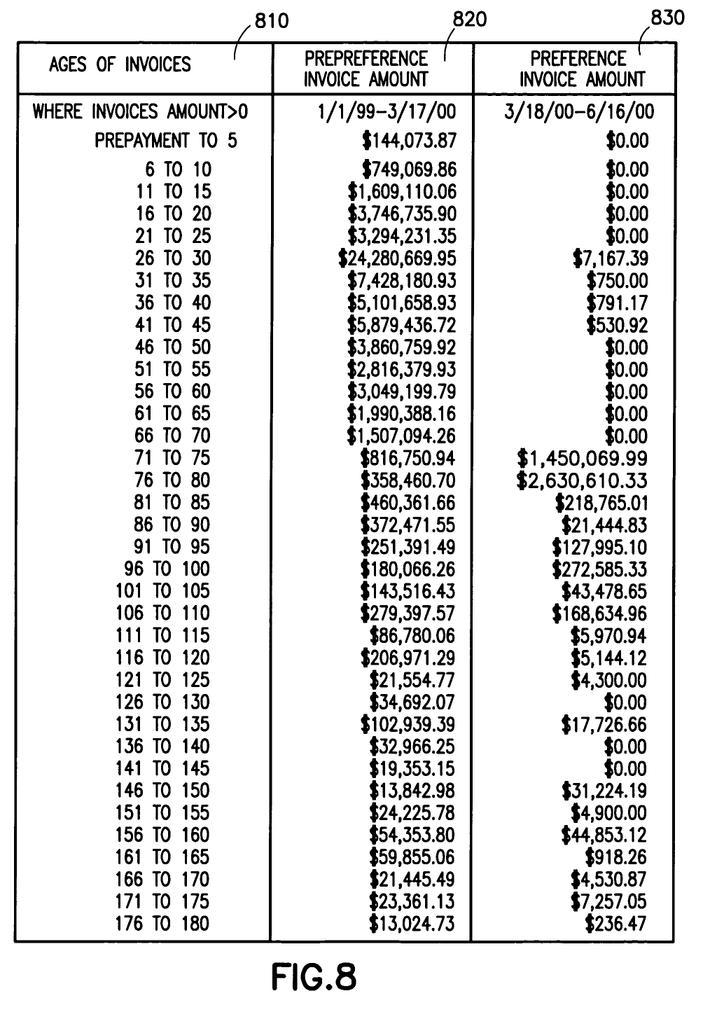

In step 725, a distribution table of dollars paid (in 5 day increments) is created, as illustrated in FIG. 8, showing both the pre-preference period payment performance and the preference period payment performance of the debtor. The first column of the table entitled Age of Invoices 810 lists the potential invoice ages of the payments made by the debtor during the pre-preference period, in five day increments. As illustrated in FIG. 8, potential invoice ages are listed from day 1 to day 180, in five day increments. The second column of the table entitled Prepreference Invoice Amount 820 lists the sum of the payment amounts made by the debtor at each five day invoice age increment during the pre-preference period. The third column of the table entitled Preference Invoice Amount 830 lists the sum of the payment amounts made by the debtor at each five day invoice age increment during the preference period. Thus, as illustrated in the example, the sum of the payment amounts made by the debtor within the invoice age of period day 71-day 75 of the pre-preference period is $816,750.94, and the sum of the payment amounts made by the debtor from an invoice age of 71-75 during the preference period is $1,450,069.99.

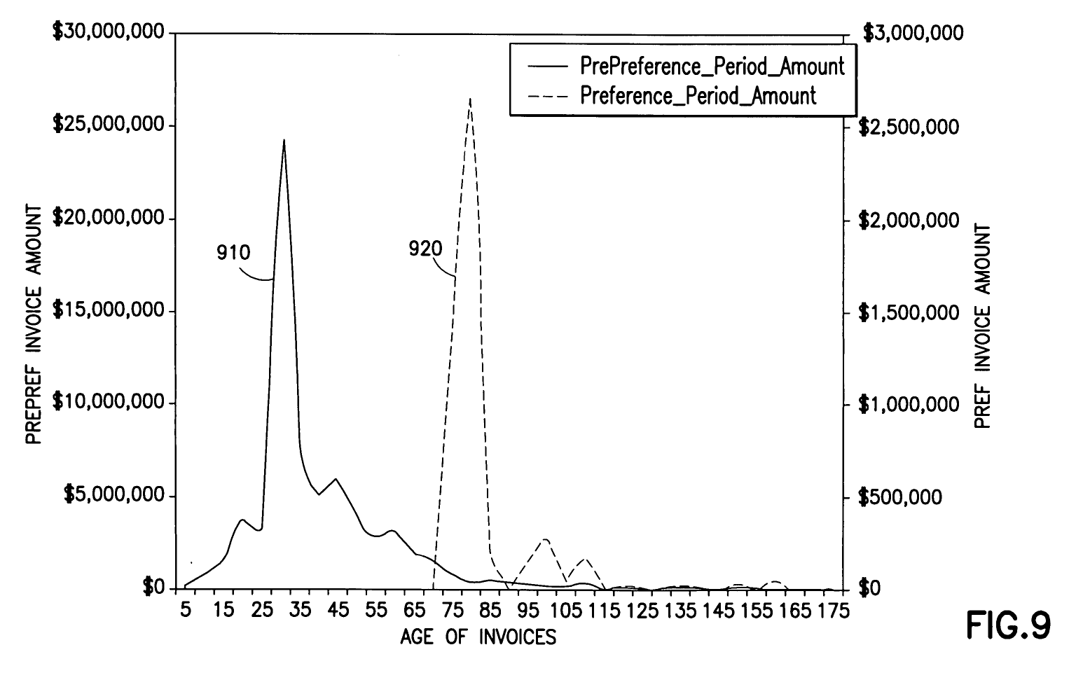

In step 730, using the data of FIG. 8, a distribution graph of dollars paid (in 5 day increments) is created, as illustrated in FIG. 9, by graphing the PrePreference Invoice Amount (Y-axis) versus the Age of Invoices (X-axis) to show the total number of invoice dollars paid at each five day invoice age increment for the pre-preference period payment performance by the debtor (the solid line plot 910) and graphing the Preference Invoice Amount (Y-axis) versus the Age of Invoices (X-axis) to show the total number of invoice dollars paid at each five day invoice age increment for the preference period payment performance by the debtor (the dotted line plot 920).

In step 735, the percent of the total payments made during the pre-preference period is calculated at each five day invoice age increment by dividing the total amount of dollars paid for each five day invoice age increment by the sum of the dollars paid by the debtor for all five day increments. The percent of the total payments made during the preference period is also calculated at each five day invoice age increment by performing the same calculation as in step 735.

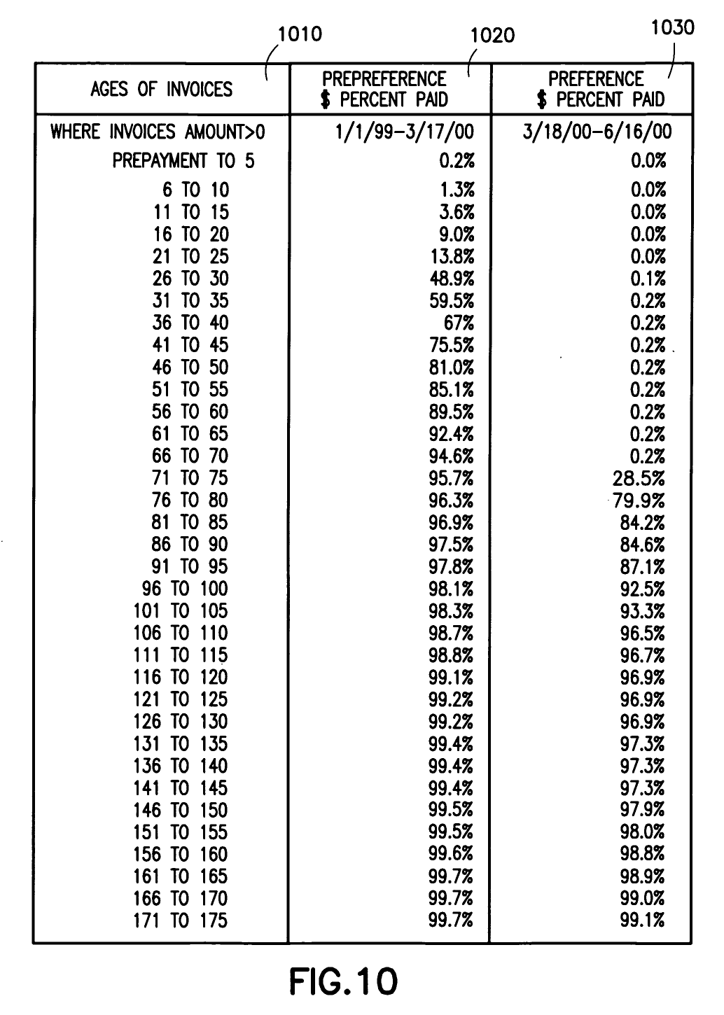

In step 740, a percent of completion table in 5 day increments can be created, as illustrated in FIG. 10, showing both the pre-preference period payment performance and the preference period payment performance of the debtor. The first column of the table entitled Age of Invoices 1010 lists the potential invoice ages of the payments made by the debtor during the pre-preference period, in five day increments. As illustrated in FIG. 10, potential invoice ages are listed from day 1 to day 180 in five day increments. The percent of the total payments made during the pre-preference period at each of the five day invoice age increment is listed in the corresponding row in the second column entitled Prepreference $ Percent Paid 1020. The percent of the total payments made during the preference period at each of the five day invoice age increment is listed in the corresponding row in the third column entitled Preference $ Percent Paid 1030. For example, in FIG. 10, the percent of the total payments made during the pre-preference period at an invoice age of 71-75 days is 95.7%, and the percent of the total payments made during the preference period at an invoice age of 71-75 days is 28.5%.

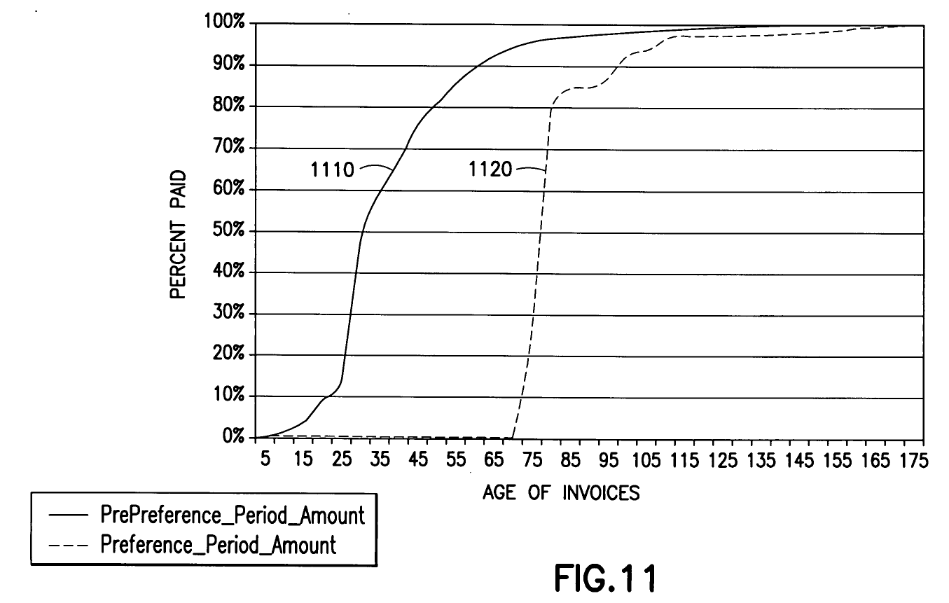

In step 745, using the data in FIG. 10, a percent of completion graph in 5 day increments can be created, as illustrated in FIG. 11, by graphing by graphing the Percent Paid (Y-axis) versus the Age of Invoices (X-axis) to show the percent of the total payments made at each five day invoice age increment for both the pre-preference period payment performance of the debtor (the solid line plot 1110) and the preference period payment performance of the debtor (the dotted line plot 1120).

At step 750, the user can determine the ordinary course brackets to be used in performing the preference analysis, as described above.

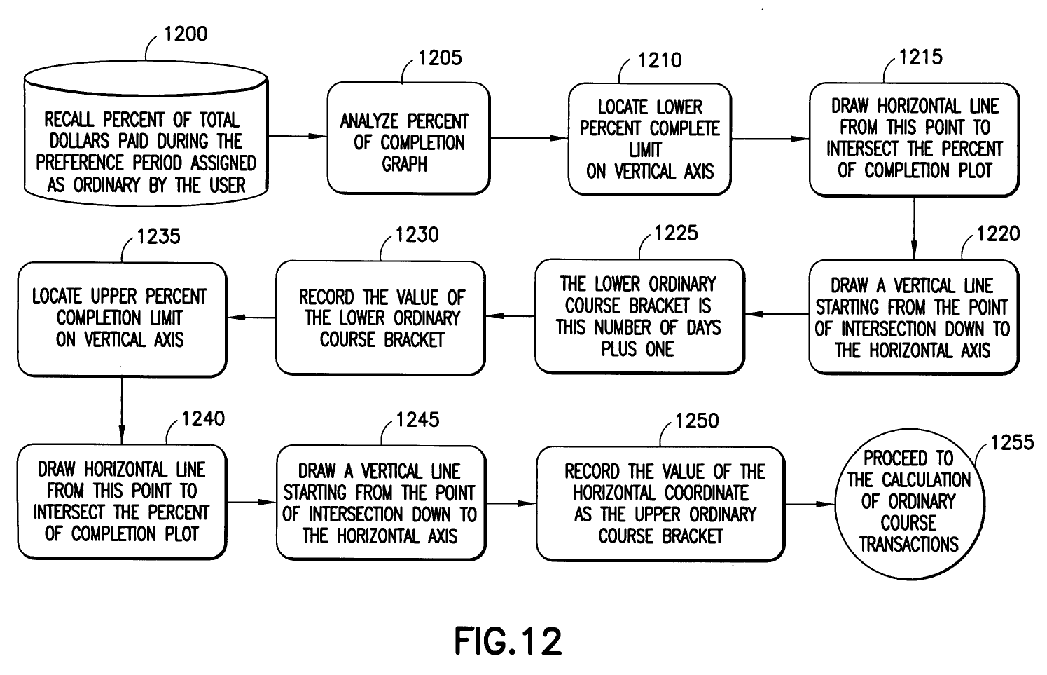

FIG. 12 is a flowchart illustrating the steps of graphical determination of the ordinary course brackets according to this embodiment of the present invention. In one embodiment of the present invention the bracket determination is done manually; however, in alternate embodiments, the bracket determination may be automated. The following steps are described in connection with the percent of completion graph illustrated in FIG. 2, but are equally applicable to, and can be practiced in conjunction with, the graphs of FIG. 11.

Referring to FIGS. 2 and 12, in step 1200, the user recalls or selects a percentage of the total number of dollars paid by the debtor during the pre-preference period to be designated as made in the ordinary course of business; the middle 68% in this example as described above. In step 1205, the percent of completion graph is analyzed, either by observation or automation. In the present example, the upper percent complete limit would occur at 84% and the lower percent complete limit would occur at 16%. In step 1210, the lower percent complete limit is located on the vertical axis of the percent of completion graph. In step 1215, a horizontal line 220 is drawn from the lower percent complete limit to the intersection of the percent of completion plot 230 (as illustrated by the dotted lines in FIG. 2). In step 1220, a vertical line 250 is drawn starting from the point of intersection down to intersect with the horizontal axis. In step 1225, the lower ordinary course bracket limit defined by line 250 is the number of days beyond this invoice age on the horizontal axis (the invoice age plus one). In step 1230, the value of the lower invoice age bracket is recorded for later use, that value being 21 days in this example.

In step 1235, the upper percent complete limit is located on the vertical axis of the percent of completion graph. In step 1240, a horizontal line 210 is drawn from the upper percent complete limit to the intersection of the percent of completion plot 230 (as illustrated by the dotted lines in FIG. 2). In step 1245, a vertical line 240 is drawn starting from the point of intersection down to intersect with the horizontal axis. In step 1250, the value of the upper ordinary course bracket limit is recorded by the user for later use, that value being 31 days in this example. In step 1255, a calculation is performed to determine whether payments by the debtor made during the preference period fall inside or outside the ordinary course brackets.

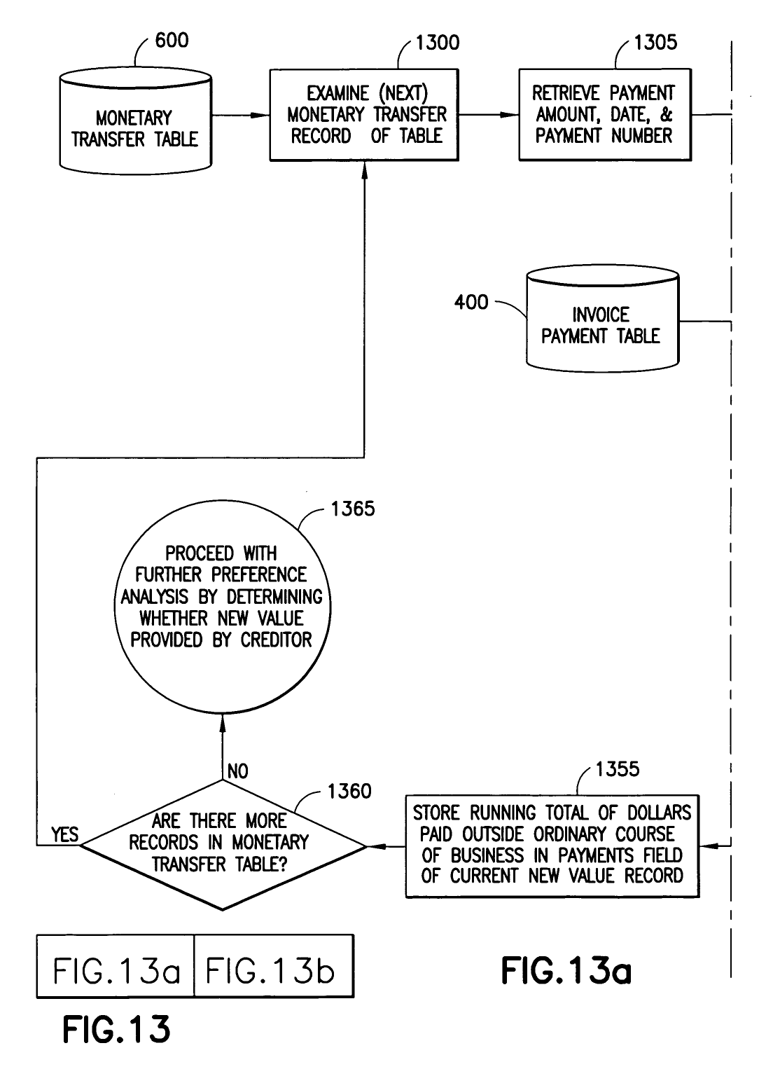

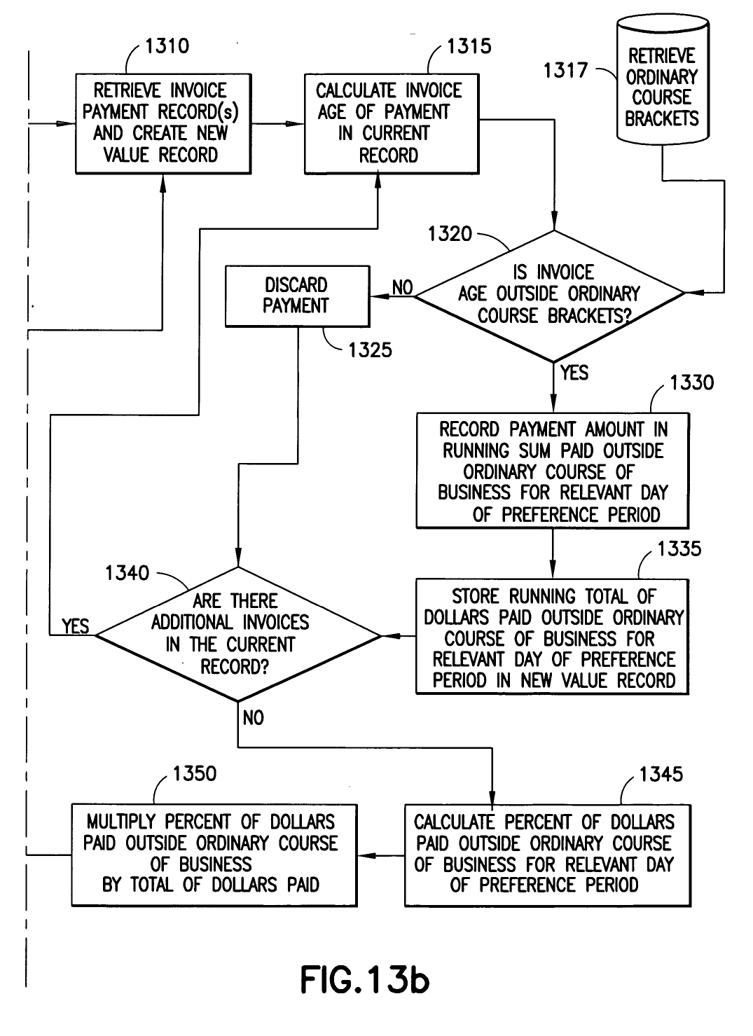

FIG. 13 is a flowchart illustrating the steps of calculation of ordinary course transactions according to this embodiment of the present invention.

Referring to FIGS. 6 and 13, in step 1300, a monetary transfer record 650 is retrieved from the monetary transfer table 600 for the targeted debtor and examined. In step 1305, the payment amount (pmt_amount 615), payment date (pmt_date 605), and payment number (pmt_number 620) in the fields of the current monetary transfer record 650 are retrieved. In step 1310, each invoice payment record 470 having a payment number, as stored in the pmt_number field 450, equivalent to the payment number, pmt_number 620, of the current monetary transfer record 650, is retrieved from the invoice payment table 400 for the targeted debtor.

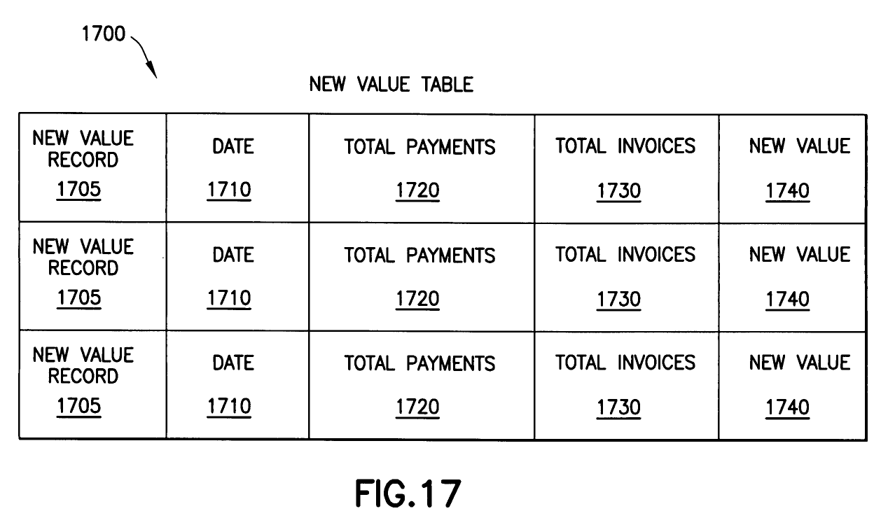

Based on the payment date corresponding to the payment number, a new value record 1705, as shown in the new value table 1700, in FIG. 17, is preferably created. A new value record 1705 is preferably created for each date of the preference period. As shown in FIG. 17, each new value record 1705 preferably contains the following data fields.

The field date 1710 represents the date of the preference period.

The field total payments 1720 represents the total of dollars paid by the debtor outside the ordinary course of business for the corresponding day of the preference period.

The field total invoices 1730 represents the total of dollars invoiced to the debtor on the corresponding day of the preference period. The field New Value 1740 represents the total of dollars paid for which new value was received on the corresponding day of the preference period.

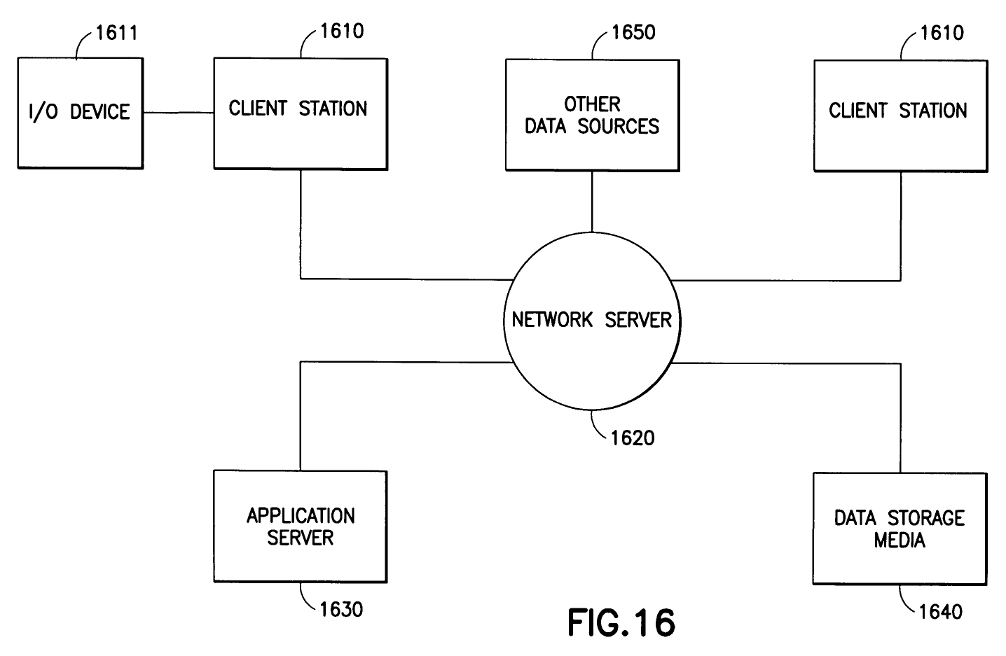

In step 1315, the invoice age of the payment contained in the current invoice payment record 470 is calculated (by the same method described earlier in step 710). In step 1317, the ordinary course brackets, as determined in FIG. 12, are entered by the user via an input device 1611, at his or her client station 1610, described herein in connection with FIG. 16. In step 1320, a determination is made as to whether the invoice age of the payment contained in the current invoice payment record 470 is within or outside the ordinary course brackets. Where it is determined, in step 1320, that the invoice age of the payment is within the ordinary course brackets, in step 1325, the payment is discarded from analysis. Where it is determined, in step 1320, that the invoice age of the payment is outside the ordinary course brackets, in step 1330, the amount of invoice dollars paid is added to a running total of invoice dollars paid outside of the ordinary course of business for that day of the preference period. In step 1335, the running total of dollars paid outside the ordinary course of business is stored in the total payments field 1720 of the new value record 1705 created for the corresponding date of the preference period on which the payment was made, date field 1710.

Following steps 1325 and 1335, it is determined, in step 1340, whether there were any additional invoices paid in the current invoice payment record 470. Where it is determined, in step 1340, that there were additional invoices paid in the current invoice payment record 470, the process returns to step 1315, and the age of the next invoice contained in the invoice payment record 470 is calculated. Where it is determined, in step 1340, that there are no additional invoices contained in the invoice payment record 470, in step 1345, the percent of invoice dollars paid outside the ordinary course of business is calculated for that day of the preference period by dividing the total dollars paid outside the ordinary course of business as stated in the total payments field 1720 by the total invoice dollars paid, as stored in the total invoices field 1730 of the new value record 1705 for the corresponding day of the preference period.

In step 1350, the percent of invoice dollars paid outside the ordinary course of business is multiplied by the amount stored in the total payments field 1720 of the current new value record 1705, to obtain the dollars paid outside the ordinary course of business for the corresponding day of the preference period. In step 1355, the running total of dollars paid outside the ordinary course of business is updated and stored in the total payments field 1720 of the current new value record. In step 1360, it is determined whether there are any additional records in the monetary transfer table 600 for the debtor. Where it is determined, in step 1360, that there are additional monetary transfer records 650 in the monetary transfer table 600, the process returns to step 1300, and the next record 650 in the monetary transfer table 600 is examined. Where it is determined, in step 1360, that there are no additional monetary transfer records 650 in the monetary transfer table 600, in step 1365, the user may proceed with further preference analysis by determining whether new value has been provided for the payments determined to be outside the ordinary course of business and stored in the new value table.

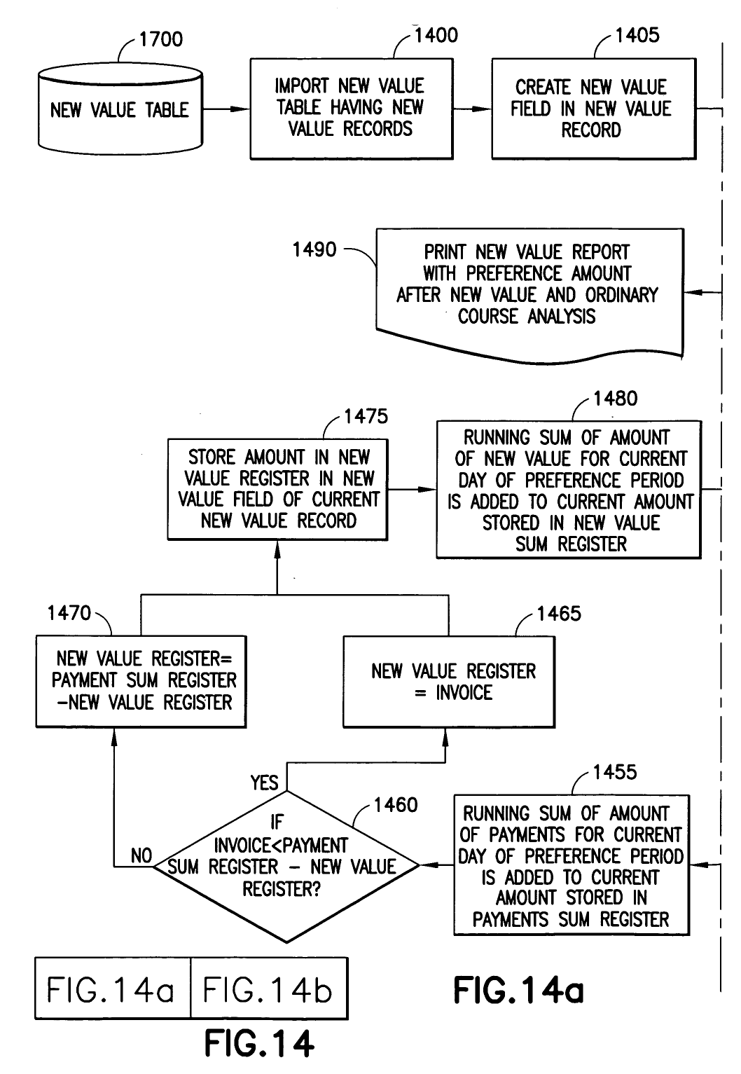

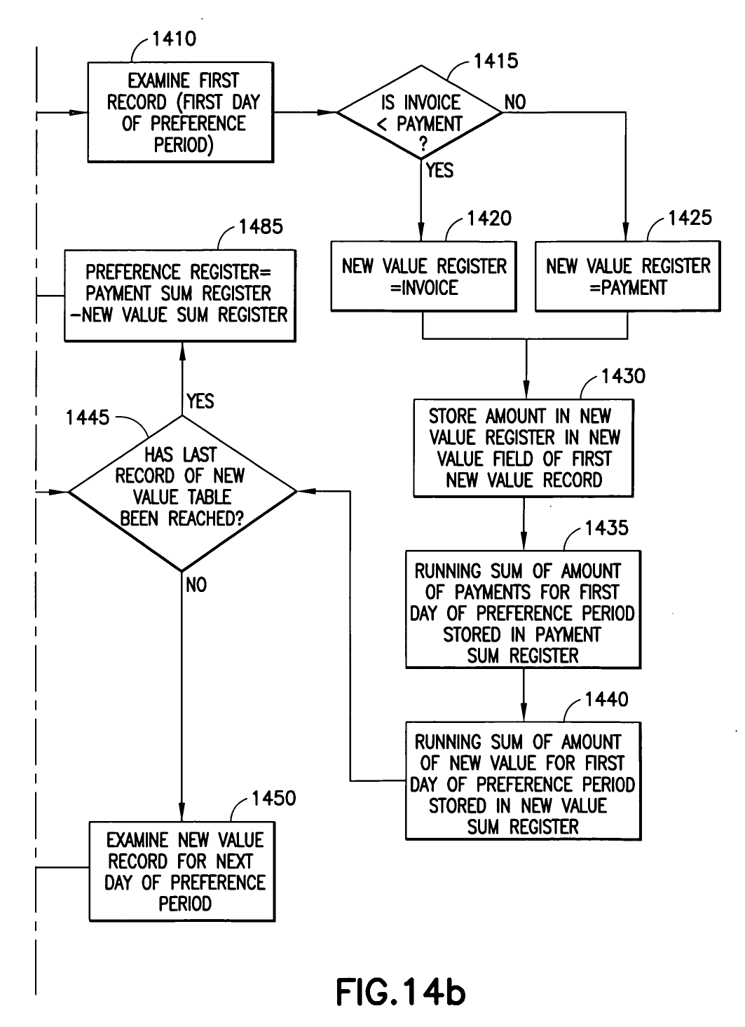

FIG. 14 is a flowchart illustrating the steps of calculation of the amount of preference payments in accordance with new value analysis for invoice payments falling outside the ordinary course of business according to this embodiment of the present invention.

In step 1400, the new value table 1700 containing the new value records 1705, having total payment dollars and total invoice dollars outside of the ordinary course of business for the each day of the preference period, is imported for the debtor. In step 1405, a new value field 1740 is created for the each new value record 1705. In step 1410, the new value record 1705 for the first day of the preference period is examined. In step 1415, it is determined whether the sum of the invoice amounts as stored in the total invoices field 1730 is less than the sum of the payment amounts as stored in the total payments field 1720, for the first day of the preference period. Where it is determined, in step 1415, that the sum of the invoice amounts is less than the sum of the payment amounts, in step 1420, a new value register is set equal to the amount in the total invoices field 1730. Where it is determined, in step 1415, that the sum of the invoice amounts is greater than or equal to the sum of the payment amounts, in step 1425, the new value register is set equal to the amount in the total payments field 1720. Following steps 1420 and 1425, in step 1430, the amount in the new value register is stored in the new value field 1740 of the first new value record 1705. In step 1435, the running sum of the payment amounts for the day of the preference period in the first new value record 1705 is calculated and stored in a payment sum register. In step 1440, the running sum of the amount of new value for the day of the preference period in the first new value record 1705 is calculated and stored in a new value sum register. In step 1445, it is determined whether the new value record 1705 for the last day of the preference period has been reached.

Where it is determined, in step 1445, that the last new value record 1705 in the new value table 1700 has not been reached, in step 1450, the new value record 1705 for the next day of the preference period is examined. In step 1455, the sum of the amount of payments for the day of the preference period in the current new value record 1705 is calculated and added to the running sum of the amount of payments for the entire preference period stored in the sum of payments register. In step 1460, it is determined whether the amount of the invoice for the day of the preference period in the current new value record is less than the current amount stored in the payment sum register (the sum of the amount of all payments up to and including that day of the preference period) minus the amount stored in the new value sum register (the sum of the amount of all new value up to and including the day before).

Where it is determined, in step 1460, that the amount of the invoice for the day of the preference period, as stored in the total invoices field 1730 in the current new value record 1705 is less than the amount in the payment sum register minus the amount in the new value sum register, in step 1465, the new value register is set equal to the amount in the total invoices field 1730 for the day of the preference period in the current new value record 1705.

Where it is determined, in step 1460, that the amount of the invoice for the day of the preference period, as stored in the total invoices field 1730 in the current new value record 1705 is greater than or equal to the amount in the payment sum register minus the amount in the new value sum register, in step 1470, the new value register is set equal to the payment sum register minus the amount in the new value sum register.

Following steps 1465 and 1470, in step 1475, the amount in the new value register is stored in the new value field of the current new value record 1705. In step 1480, the sum of the amount of new value for the day of the preference period in the current new value record 1705 is added to the running the sum of the amount of new value for the entire preference period stored in the new value sum register. The process then returns to determine whether the new value record for the last day of the preference period has been reached, in step 1445.

Where it is determined, in step 1445, that new value record 1705 for the last day of the preference period has been reached, in step 1485, a preference register is set equal to the amount in the payment sum register minus the amount in the new value sum register. In step 1490, the total preference payment amount for the preference period, as stored in the preference register, may be displayed and/or printed in the form of a new value report, as illustrated in connection with the FIGS. 15a through 15d.

The system and methods of the above-described embodiments can be implemented as an automated system comprising known computing, communication and networking components, as illustrated in FIG. 16; namely a client station 1610, an application server 1620, and a network server 1630, and one or more data storage media 1640 storing data relating to invoice and payment data, such as an accounts payable database, a bank database, or a check register.

In a preferred embodiment, client stations 1610 are computing devices or processors, such as a personal computer (PC), computer workstation, personal digital assistant (PDA), web-enabled cellular telephone, and the like, having various input and output devices 1611 through which data can be entered, programs integrated with, output perceived and information exchanged, such as for example keyboards, displays, printers, routing devices and the like. One or more client stations 1610 may be coupled to a network server 1620 via any known or hereafter developed networks or communication methodologies, such as for example, a local area network, wide area network, the Internet, World Wide Web, wireless network, virtual private network and the like, utilizing any type of communication protocol, such as Ethernet, IP addressing, http and the like.

Network server 1620 is coupled to the application server 1630 via any of a number of types of network utilizing essentially any type of communication protocol, as described above in connection with the coupling between the network server 1620 and the one or more client stations 1610. The network server 1620 is also coupled to the one or more data storage media 1640 via any of a number of types of network utilizing essentially any type of communication protocol, as described above in connection with the coupling between the network server 1620 and the one or more client stations 1610.

In the present embodiment, application server 1630 has running thereon one or more software applications, such as that offered by Microsoft Corporation under the tradename Microsoft Access. The processes described in connection with FIGS. 1-15 herein may be implemented for operation in accordance with one or more applications of the same or similar type of functionality of Microsoft Access, with computer code in any known or hereafter known programming languages, such as for example Visual Basic. Additionally, the data tables, data records, data fields, storage and counter variables and registers described herein may be implemented and stored in the one or more database applications, such as for example Microsoft Access.

It is to be understood that the use of Microsoft Access and Visual Basic to implement this embodiment of the present invention is merely an exemplary choice of design. In alternate embodiments, the methods and systems of the present invention may be implemented in varying processors and/or software applications and may utilize a variety of different programming languages, or may be implemented manually by a person performing the preference analysis. In one such alternate embodiment, the user of the system may access the application software via an application server and implement the methods and systems of the present invention, via one or more web pages provided on a web-enabled client station.

A user of the system may open an instance of Microsoft Access on his or her client station 1610 via the coupling between the client station 1610, the network server 1620 and the application server 1630 having the one or more instances of Microsoft Access running thereon. The user of the system may select, via a graphical user interface provided at his or her client station 1610, whether to enter or import data, such as invoice data, payment data, monetary transfer data, and new value data to the system, as described herein in connection with FIGS. 1-15. Where a user chooses to import data to the system, the data may be retrieved from the one or more data storage media 1640 via the network server 1620 and stored in the one or more instances of Microsoft Access running on the application server 1630 or other data sources 1650. A user of the system may also select, via a graphical user interface, to process the data, as described herein in connection with FIGS. 1-15, to perform preference analysis, such as ordinary course of business analysis, new value analysis, or to combine both ordinary course of business analysis and new value analysis. The user of this system may also select, via the graphical user interface, to generate one or more tables, graphs, and charts, as described above in connection with FIGS. 1-15, and additionally to view or print such tables, graphs, and charts.

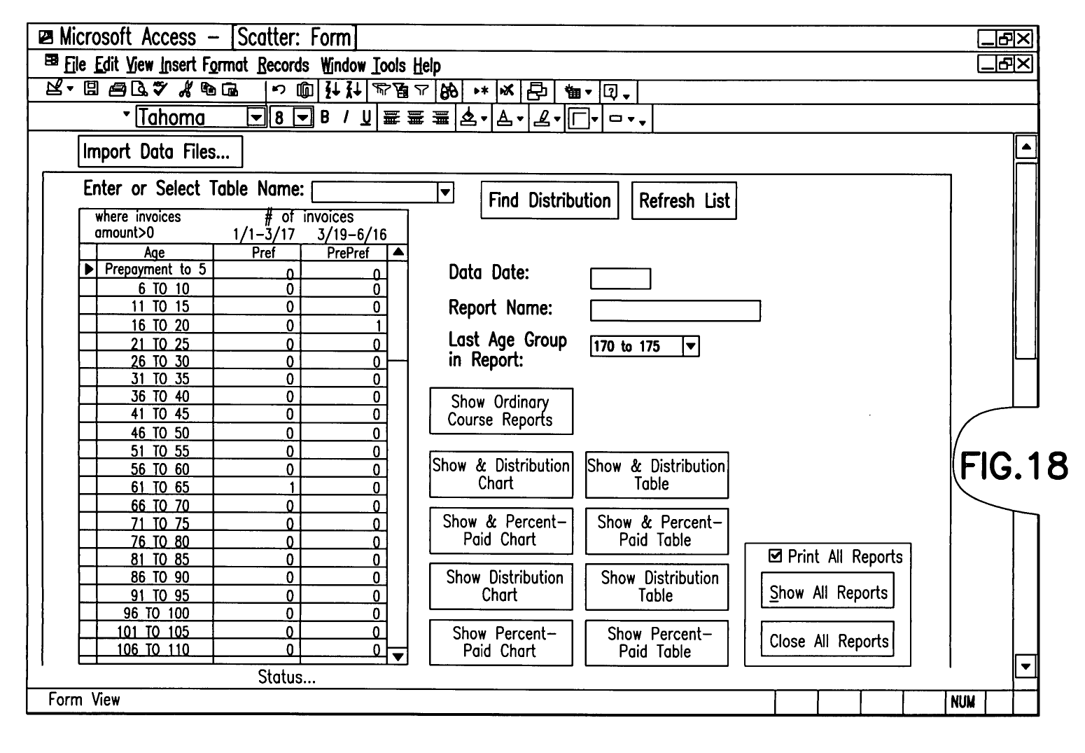

FIGS. 18-20 illustrate exemplary screen shots of a graphical user interface according to one embodiment of the present invention.

FIG. 18 is illustrative of a scatter form according to one embodiment of the present invention, which enables a user of the method and system to view or print tables and reports generated by the exemplary embodiment described in connection with FIGS. 1, 2, and 7-11.

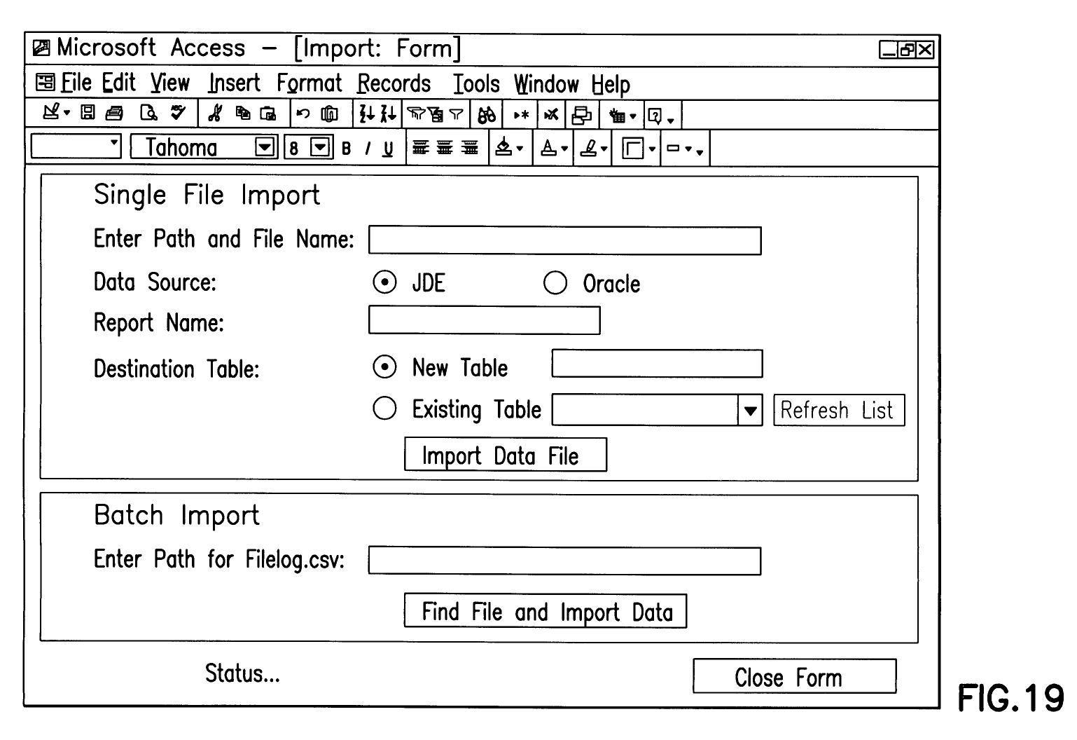

FIG. 19 is illustrative of an import form according to one embodiment of the present invention, which enables a user of the method and system to import invoice payment data and monetary transfer data to generate invoice payment records and monetary transfer records as described in connection with the exemplary embodiment in FIGS. 3-6.

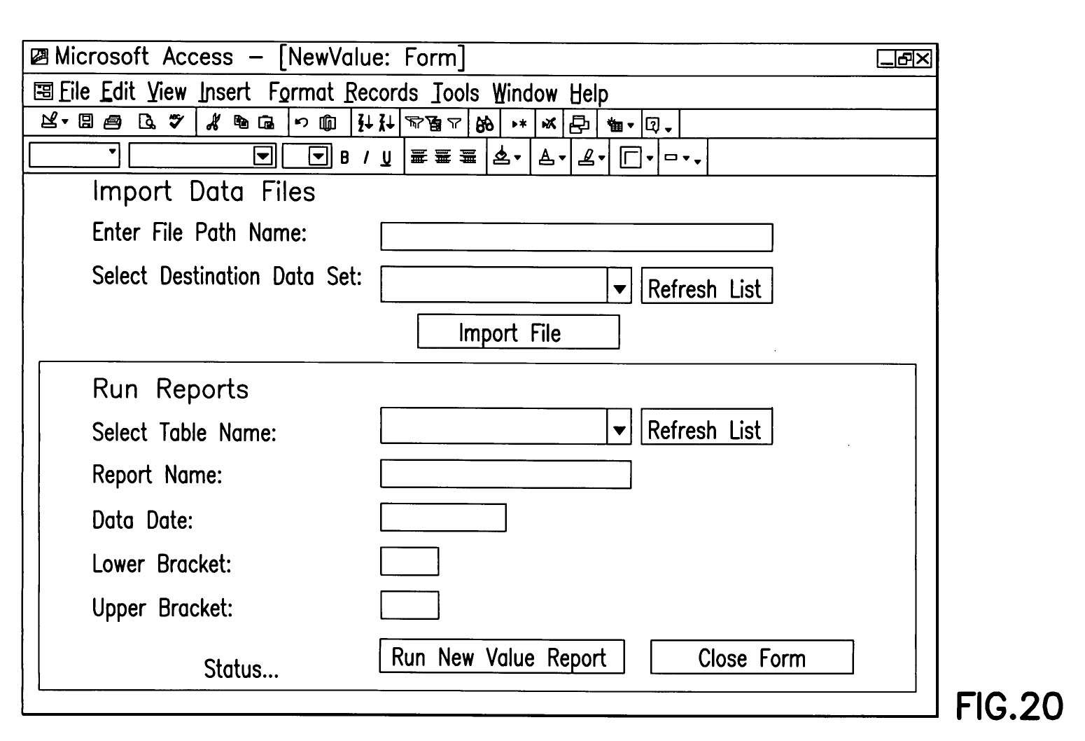

FIG. 20 is illustrative of a new value form according to one embodiment of the present invention, which enables a user of the method and system to import new value records and to generate new value reports in connection with the exemplary embodiment in FIGS. 13, 14, 15a-15d, and 17.

It is to be understood that the processing and calculation of data, along with the generation of tables, graphs, and reports described in the methods and systems herein are merely exemplary and that all such calculations, and generation of tables, graphs, and reports may be accomplished manually or electronically. Such tables, graphs, reports, and calculations may be viewable in a variety of manners, including, but not limited to being written on paper or being electronically viewable or printable via an output device, such as a monitor, printer, other output devices described herein and the like. Additionally, such calculations, tables, graphs, and reports may be used for perception and analysis or to perform further calculations, analysis, or generation of tables, graphs, charts, reports, and the like.

Those skilled in the art will recognize that the method and system of the present invention has many applications, may be implemented in a variety of manners now known or hereafter to become known, and, as such, is not limited by the foregoing exemplary embodiments and examples. It is to be understood that the steps in the foregoing embodiments may be performed in any suitable order, combined into fewer steps or divided into more steps. Thus, the scope of the present invention covers conventionally known and future developed variations and modifications to the system components described herein, as would be understood by those skilled in the art.

Additionally, the functionality of the components of the foregoing embodiments may be implemented in different manners. It is to be understood that the methods and systems described in the present invention may be implemented in any number of hardware, firmware, and software components. Any number of system components, in varying hardware, software or firmware combinations may be utilized within the scope of the present invention.

Also, it should be understood that the present invention may operate on a stand-alone device, such as a stand-alone personal computer or may be implemented on any network, such as a local area network, wide area network, company intranet, the Internet or World Wide Web, or other communication network now known or hereafter to become known.

Furthermore, it should be understood that the description of the data storage, including the databases, data tables, data records, data files, data fields, variables, and registers of the embodiments described herein are merely an illustrative logical arrangement of exemplary data and more or less data may be stored in different embodiments, and such data may be arranged in fewer or more databases, tables, records, or files. In alternate embodiments, tables could be stored in one or more databases or other data storage media, as part of one or more components or a separate component. Any of the one or more databases could be accessible, via a communicative coupling, to any of the aforementioned components of the present embodiment.

What is claimed is:

1. A system for performing preference analysis, operable in connection with software to:
receive preference period payment data relating to one or more invoice payments from a debtor to a creditor made during a predetermined preference period;
analyze said preference period invoice payment data in accordance with predetermined ordinary course parameters to determine whether one or more of said invoice payments falls within or outside a universe of invoice payments made in the ordinary course of business;
analyze said preference period invoice payment data in accordance with predetermined new value parameters to determine whether an amount of one or more or a portion of an amount of one or more invoice payments determined to fall outside of said universe of invoice payments made in the ordinary course of business was made in exchange for new value provided by said creditor to said debtor, wherein an amount of one or more of or a portion of an amount of said invoice payments falling outside said universe of invoice payments made in the ordinary course of business and determined not to be made in exchange for new value is determined to be a potentially voidable preference payment amount; and
create a record of said potentially voidable preference payment amount.

2. The system of claim 1, wherein said system is further operable in connection with software to receive pre-preference period invoice payment data for one or more invoices, said pre-preference period invoice payment data comprising an invoice payment amount and a respective invoice age said pre-preference period invoice payment data relating to one or more invoice payments from said debtor to said creditor made during a predetermined pre-preference period, wherein said ordinary course parameters comprise an invoice age range determined by analyzing said pre-preference period invoice payment data to identify an upper invoice age limit and a lower invoice age limit, and wherein one or more of said invoice payments made during said predetermined preference period must have an invoice age within said invoice age range to be considered to fall within said universe of payments made in the ordinary course of business.

3. The system of claim 2, wherein said invoice age range determination comprises:
calculating a total representing a denominator sum of the amounts of said invoice payments at all invoice ages for a predetermined number of said payments made during said pre-preference period;
grouping one or more of said invoice ages into a plurality of invoice age increments and calculating a numerator sum of the amounts of said invoice payments at one or more of said invoice age increments; and
dividing said numerator sum by said denominator sum so as to determine a percent of completion at one or more of said invoice age increments.

4. The system of claim 3, wherein said invoice age range determination further comprises:
determining said upper invoice age limit by correlating a predetermined upper percent of completion limit with said percent of completion at one of said invoice age increments; and
determining said lower invoice age limit by correlating a predetermined lower percent of completion limit with said percent of completion at another one of said invoice age increments.

5. The system of claim 4, wherein said invoice age range determination further comprises creating a table comprising one or more of said invoice age increments, said numerator sum of the amounts of invoice payments at one or more of said invoice age increments, and said percent of completion at one or more of said invoice age increments.

6. The system of claim 4, wherein said invoice age range determination further comprises creating a user perceptible graph comprising one or more of said invoice age increments, said numerator sum of the amounts of invoice payments at one or more of said invoice age increments, and said percent of completion at one or more of said invoice age increments.

7. The system of claim 3, wherein each of said invoice age increments comprises one invoice age.

8. The system of claim 3, wherein each of said invoice age increments comprises five invoice ages.

9. The system of claim 1, wherein said determination of said potentially voidable preference payment amount is determined by subtracting a total sum of new value from a total sum of the amount of said invoice payments falling outside said universe of invoice payments made in the ordinary course of business, wherein said total sum of new value is determined by:
calculating a daily sum of amounts of invoice payments for a day of said preference period;
calculating a daily sum of amounts invoiced for said day of said preference period;
calculating a total sum of amounts of invoice payments by adding together said daily sum of amounts of invoice payments for each day of said preference period up to and including said day;
calculating a total sum of new value by adding together a daily sum of new value for each day of said preference period up to and including one day before said day;
calculating said daily sum of new value, wherein said daily sum of new value is equal to:
said daily sum of amounts invoiced, if said daily sum of amount invoiced is less than a difference determined by subtracting said total sum of new value from said total sum of amounts of invoice payments, or
said difference, if said daily sum of amounts invoiced is greater than said difference;
calculating said total sum of new value by adding together said daily sum of new value for each day of said preference period.

10. A system for performing preference analysis, operable in connection with software to:
receive preference period invoice payment data relating to one or more invoice payments from a debtor to a creditor made during a predetermined preference period;
receive pre-preference period invoice payment data for one or more invoices, said pre-preference period invoice payment data comprising an invoice payment amount and a respective invoice age, said pre-preference period invoice payment data relating to one or more invoice payments from said debtor to said creditor made during a predetermined pre-preference period;
determine ordinary course parameters by analyzing said pre-preference period invoice payment data, wherein said ordinary course parameters comprise an invoice age range comprising an upper invoice age limit and a lower invoice age limit, said invoice age range determined by:
calculating a total representing a denominator sum of the amounts of said invoice payments at all invoice ages for a predetermined number of said payments made during said pre-preference period;
grouping one or more of said invoice ages into a plurality of invoice age increments and calculating a numerator sum of the amounts of said invoice payments at one or more of said invoice age increments; and
dividing said numerator sum by said denominator so as to determine a percent of completion at one or more of said invoice age increments;
analyze said preference period invoice payment data to determine whether an invoice age of one or more of said payments made during said preference period is within or outside of said invoice age range, and wherein one or more of said invoice payments made during said preference period must have an invoice age outside said invoice age range to be considered to fall outside a universe of payments made in the ordinary course of business and be considered a potentially voidable preference payment; and
create a record of said potentially voidable preference payment.

11. The system of claim 10, wherein said invoice age range determination further comprises:
determining said upper invoice age limit by correlating a predetermined upper percent of completion limit with said percent of completion at one of said invoice age increments; and
determining said lower invoice age limit by correlating a predetermined lower percent of completion limit with said percent of completion at another one of said invoice age increments.

12. The system of claim 11, wherein said invoice age range determination further comprises creating a table comprising one or more of said invoice age increments, said numerator sum of the amounts of said invoice payments at one or more of said invoice age increments, and said percent of completion at one or more of said invoice age increments.

13. The system of claim 11, wherein said invoice age range determination further comprises creating a user perceptible graph comprising one or more of said invoice age increments, said numerator sum of the amounts of said invoice payments at one or more of said invoice age increments, and said percent of completion at one or more of said invoice age increments.

14. The system of claim 10, wherein each of said invoice age increments comprises one invoice age.

15. The system of claim 10, wherein each of said invoice age increments comprises five invoice ages.

16. A method for performing preference analysis comprising:
receiving preference period payment data relating to one or more invoice payments from a debtor to a creditor made during a predetermined preference period;
analyzing said preference period invoice payment data in accordance with predetermined ordinary course parameters to determine whether one or more of said invoice payments falls within or outside a universe of invoice payments made in the ordinary course of business;
analyzing said preference period invoice payment data in accordance with predetermined new value parameters to determine whether an amount of one or more or a portion of an amount of one or more of invoice payments determined to fall outside of said universe of invoice payments made in the ordinary course of business was made in exchange for new value provided by said creditor to said debtor, wherein an amount of one or more or a portion of an amount of one or more of said invoice payments falling outside said universe of invoice payments made in the ordinary course of business and determined not to be made in exchange for new value is determined to be a potentially voidable preference payment amount; and
creating a record of said potentially voidable preference payment amount.

17. The method of claim 16, further comprising receiving pre-preference period invoice payment data for one or more invoices, said pre-preference period invoice payment data comprising an invoice payment amount and a respective invoice age said pre-preference period invoice payment data relating to one or more invoice payments from said debtor to said creditor made during a predetermined pre-preference period, wherein said ordinary course parameters comprise an invoice age range determined by analyzing said pre-preference period invoice payment data to identify an upper invoice age limit and a lower invoice age limit, and wherein one or more of said invoice payments made during said predetermined preference period must have an invoice age within said invoice age range to be considered to fall within said universe of payments made in the ordinary course of business.

18. The method of claim 17, wherein said invoice age range determination comprises:
calculating a total representing a denominator sum of the amounts of said invoice payments at all invoice ages for a predetermined number of said payments made during said pre-preference period;
grouping one or more of said invoice ages into a plurality of invoice age increments and calculating a numerator sum of the amounts of said invoice payments at one or more of said invoice age increments; and
dividing said numerator sum by said denominator sum so as to determine a percent of completion at one or more of said invoice age increments.

19. The method of claim 18, wherein said invoice age range determination further comprises:
determining said upper invoice age limit by correlating a predetermined upper percent of completion limit with said percent of completion at one of said invoice age increments; and
determining said lower invoice age limit by correlating a predetermined lower percent of completion limit with said percent of completion at another one of said invoice age increments.

20. The method of claim 19, wherein said invoice age range determination further comprises creating a table comprising one or more of said invoice age increments, said numerator sum of the amounts of said invoice payments at one or more of said invoice age increments, and said percent of completion at one or more of said invoice age increments.

21. The method of claim 19, wherein said invoice age range determination further comprises creating a user perceptible graph comprising one or more of said invoice age increments, said numerator sum of the amounts of said invoice payments at one or more of said invoice age increments, and said percent of completion at one or more of said invoice age increments.

22. The method of claim 18, wherein each of said invoice age increments comprises one invoice age.

23. The method of claim 18, wherein each of said invoice age increments comprises five invoice ages.

24. The method of claim 16, wherein said determination of said potentially voidable preference payment amount is determined by subtracting a total sum of new value from a total sum of the amount of said invoice payments falling outside said universe of invoice payments made in the ordinary course of business, wherein said total sum of new value is determined by:
calculating a daily sum of amounts of invoice payments for a day of said preference period;
calculating a daily sum of amounts invoiced for said day of said preference period;
calculating a total sum of amounts of invoice payments by adding together said daily sum of amounts of invoice payments for each day of said preference period up to and including said day;
calculating a total sum of new value by adding together a daily sum of new value for each day of said preference period up to and including one day before said day;
calculating said daily sum of new value, wherein said daily sum of new value is equal to:
said daily sum of amounts invoiced, if said daily sum of amount invoiced is less than a difference determined by subtracting said total sum of new value from said total sum of amounts of invoice payments, or
said difference, if said daily sum of amounts invoiced is greater than said difference;
calculating said total sum of new value by adding together said daily sum of new value for each day of said preference period.

25. A method for performing preference analysis comprising:
receiving preference period invoice payment data relating to one or more invoice payments from a debtor to a creditor made during a predetermined preference period;
receiving pre-preference period invoice payment data for one or more invoices, said pre-preference period invoice payment data comprising an invoice payment amount and a respective invoice age, said pre-preference period invoice payment data relating to one or more invoice payments from said debtor to said creditor made during a predetermined pre-preference period;
determining ordinary course parameters by analyzing said pre-preference period invoice payment data, wherein said ordinary course parameters comprise an invoice age range comprising an upper invoice age limit and a lower invoice age limit, said invoice age range determined by:
calculating a total representing a denominator sum of the amounts of said invoice payments at all invoice ages for a predetermined number of said payments made during said pre-preference period;
grouping one or more of said invoice ages into a plurality of invoice age increments and calculating a numerator sum of the amounts of said invoice payments at one or more of said invoice age increments; and
dividing said numerator sum by said denominator so as to determine a percent of completion at one or more of said invoice age increments;
analyzing said preference period invoice payment data to determine whether an invoice age of one or more of said payments made during said preference period is within or outside of said invoice age range, and wherein one or more of said invoice payments made during said preference period must have an invoice age outside said invoice age range to be considered to fall outside a universe of payments made in the ordinary course of business and be considered a potentially voidable preference payment; and
creating a record of said potentially voidable preference payment.

26. The method of claim 25, wherein said invoice age range determination further comprises:
determining said upper invoice age limit by correlating a predetermined upper percent of completion limit with said percent of completion at one of said invoice age increments; and
determining said lower invoice age limit by correlating a predetermined lower percent of completion limit with said percent of completion at another one of said invoice age increments.

27. The method of claim 26, wherein said invoice age range determination further comprises creating a table comprising one or more of said invoice age increments, said numerator sum of the amounts of said invoice payments at one or more of said invoice age increments, and said percent of completion at one or more of said invoice age increments.

28. The method of claim 26, wherein said invoice age range determination further comprises creating a user perceptible graph comprising one or more of said invoice age increments, said numerator sum of the amounts of said invoice payments at one or more of said invoice age increments, and said percent of completion at one or more of said invoice age increments.

29. The method of claim 25, wherein each of said invoice age increments comprises one invoice age.

30. The method of claim 25, wherein each of said invoice age increments comprises five invoice ages.

31. A system for performing preference analysis, operable in connection with software to:
receive preference period payment data relating to one or more invoice payments from a debtor to a creditor made during a predetermined preference period;
analyze said preference period invoice payment data in accordance with predetermined ordinary course parameters to determine whether one or more of said invoice payments falls within or outside a universe of invoice payments made in the ordinary course of business;
analyze said preference period invoice payment data in accordance with predetermined new value parameters to determine whether an amount of one or more or a portion of an amount of said invoice payments was made in exchange for new value provided by said creditor to said debtor,
wherein an amount of one or more or a portion of an amount of one or more of said invoice payments falling outside said universe of invoice payments made in the ordinary course of business and determined not to be made in exchange for new value is determined to be a potentially voidable preference payment amount; and
create a record of said potentially voidable preference payment amount.

32. The system of claim 31, wherein said system is further operable in connection with software to receive pre-preference period invoice payment data for one or more invoices, said pre-preference period invoice payment data comprising an invoice payment amount and a respective invoice age said pre-preference period invoice payment data relating to one or more invoice payments from said debtor to said creditor made during a predetermined pre-preference period, wherein said ordinary course parameters comprise an invoice age range determined by analyzing said pre-preference period invoice payment data to identify an upper invoice age limit and a lower invoice age limit, and wherein one or more of said invoice payments made during said predetermined preference period must have an invoice age within said invoice age range to be considered to fall within said universe of payments made in the ordinary course of business.

33. The system of claim 32, wherein said invoice age range determination comprises:
calculating a total representing a denominator sum of the amounts of said invoice payments at all invoice ages for a predetermined number of said payments made during said pre-preference period;
grouping one or more of said invoice ages into a plurality of invoice age increments and calculating a numerator sum of the amounts of said invoice payments at one or more of said invoice age increments; and
dividing said numerator sum by said denominator sum so as to determine a percent of completion at one or more of said invoice age increments.

34. The system of claim 33, wherein said invoice age range determination further comprises:
determining said upper invoice age limit by correlating a predetermined upper percent of completion limit with said percent of completion at one of said invoice age increments; and
determining said lower invoice age limit by correlating a predetermined lower percent of completion limit with said percent of completion at another one of said invoice age increments.

35. The system of claim 34, wherein said invoice age range determination further comprises creating a table comprising one or more of said invoice age increments, said numerator sum of the amounts of said invoice payments at one or more of said invoice age increments, and said percent of completion at one or more of said invoice age increments.

36. The system of claim 34, wherein said invoice age range determination further comprises creating a user perceptible graph comprising one or more of said invoice age increments, said numerator sum of the amounts of said invoice payments at one or more of said invoice age increments, and said percent of completion at one or more of said invoice age increments.

37. The system of claim 33, wherein each of said invoice age increments comprises one invoice age.

38. The system of claim 33, wherein each of said invoice age increments comprises five invoice ages.

39. A method for performing preference analysis comprising:
receiving preference period payment data relating to one or more invoice payments from a debtor to a creditor made during a predetermined preference period;
analyzing said preference period invoice payment data in accordance with predetermined ordinary course parameters to determine whether one or more of said invoice payments falls within or outside a universe of invoice payments made in the ordinary course of business;
analyzing said preference period invoice payment data in accordance with predetermined new value parameters to determine whether an amount of one or more or a portion of an amount of one or more of said invoice payments was made in exchange for new value provided by said creditor to said debtor,
wherein an amount of one or more or a portion of an amount of one or more of said invoice payments falling outside said universe of invoice payments made in the ordinary course of business and determined not to be made in exchange for new value is determined to be a potentially voidable preference payment amount; and
creating a record of said potentially voidable preference payment amount.

40. The method of claim 39, further comprising receiving pre-preference period invoice payment data for one or more invoices, said pre-preference period invoice payment data comprising an invoice payment amount and a respective invoice age said pre-preference period invoice payment data relating to one or more invoice payments from said debtor to said creditor made during a predetermined pre-preference period, wherein said ordinary course parameters comprise an invoice age range determined by analyzing said pre-preference period invoice payment data to identify an upper invoice age limit and a lower invoice age limit, and wherein one or more of said invoice payments made during said predetermined preference period must have an invoice age within said invoice age range to be considered to fall within said universe of payments made in the ordinary course of business.

41. The method of claim 40, wherein said invoice age range determination comprises:
calculating a total representing a denominator sum of the amounts of said invoice payments at all invoice ages for a predetermined number of said payments made during said pre-preference period;
grouping one or more of said invoice ages into a plurality of invoice age increments and calculating a numerator sum of the amounts of said invoice payments at one or more of said invoice age increments; and
dividing said numerator sum by said denominator sum so as to determine a percent of completion at one or more of said invoice age increments.

42. The method of claim 41, wherein said invoice age range determination further comprises:
determining said upper invoice age limit by correlating a predetermined upper percent of completion limit with said percent of completion at one of said invoice age increments; and
determining said lower invoice age limit by correlating a predetermined lower percent of completion limit with said percent of completion at another one of said invoice age increments.

43. The method of claim 42, wherein said invoice age range determination further comprises creating a table comprising one or more of said invoice age increments, said numerator sum of the amounts of said invoice payments at one or more of said invoice age increments, and said percent of completion at one or more of said invoice age increments.

44. The method of claim 42, wherein said invoice age range determination further comprises creating a user perceptible graph comprising one or more of said invoice age increments, said numerator sum of the amounts of said invoice payments at one or more of said invoice age increments, and said percent of completion at one or more of said invoice age increments.

45. The method of claim 41, wherein each of said invoice age increments comprises one invoice age.

46. The method of claim 41, wherein each of said invoice age increments comprises five invoice ages.

47. A computer readable medium for performing preference analysis configured to:
receive preference period payment data relating to one or more invoice payments from a debtor to a creditor made during a predetermined preference period;
analyze said preference period invoice payment data in accordance with predetermined ordinary course parameters to determine whether one or more of said invoice payments falls within or outside a universe of invoice payments made in the ordinary course of business;
analyze said preference period invoice payment data in accordance with predetermined new value parameters to determine whether an amount of one or more or a portion of an amount of one or more of invoice payments determined to fall outside of said universe of invoice payments made in the ordinary course of business was made in exchange for new value provided by said creditor to said debtor, wherein an amount of one or more or a portion of an amount of one or more of said invoice payments falling outside said universe of invoice payments made in the ordinary course of business and determined not to be made in exchange for new value is determined to be a potentially voidable preference payment amount; and
create a record of said potentially voidable preference payment amount.

48. A computer readable medium configured to:
receive preference period payment data relating to one or more invoice payments from a debtor to a creditor made during a predetermined preference period;
analyze said preference period invoice payment data in accordance with predetermined ordinary course parameters to determine whether one or more of said invoice payments falls within or outside a universe of invoice payments made in the ordinary course of business;
analyze said preference period invoice payment data in accordance with predetermined new value parameters to determine whether an amount of one or more or a portion an amount of one or more of said invoice payments was made in exchange for new value provided by said creditor to said debtor,
wherein an amount of one or more or a portion of an amount of one or more of said invoice payments falling outside said universe of invoice payments made in the ordinary course of business and determined not to be made in exchange for new value is determined to be a potentially voidable preference payment amount; and
create a record of said potentially voidable preference payment amount.

49. A computer readable medium configured to:
receive preference period invoice payment data relating to one or more invoice payments from a debtor to a creditor made during a predetermined preference period;
receive pre-preference period invoice payment data for one or more invoices, said pre-preference period invoice payment data comprising an invoice payment amount and a respective invoice age, said pre-preference period invoice payment data relating to one or more invoice payments from said debtor to said creditor made during a predetermined pre-preference period;
determine ordinary course parameters by analyzing said pre-preference period invoice payment data, wherein said ordinary course parameters comprise an invoice age range comprising an upper invoice age limit and a lower invoice age limit, said invoice age range determined by:
calculating a total representing a denominator sum of the amounts of said invoice payments at all invoice ages for a predetermined number of said payments made during said pre-preference period;
grouping one or more of said invoice ages into a plurality of invoice age increments and calculating a numerator sum of the amounts of said invoice payments at one or more of said invoice age increments; and
dividing said numerator sum by said denominator so as to determine a percent of completion at one or more of said invoice age increments;
analyzing said preference period invoice payment data to determine whether an invoice age of one or more of said payments made during said preference period is within or outside of said invoice age range, and wherein one or more of said invoice payments made during said preference period must have an invoice age outside said invoice age range to be considered to fall outside a universe of payments made in the ordinary course of business and be determined a potentially voidable preference payment; and
creating a record of said potentially voidable preference payment.

50. A system for performing preference analysis, operable in connection with software to:
receive preference period invoice payment data relating to one or more invoice payments from a debtor to a creditor made during a predetermined preference period;
receive pre-preference period invoice payment data for one or more invoices, said pre-preference period invoice payment data comprising an invoice payment amount and a respective invoice age, said pre-preference period invoice payment data relating to one or more invoice payments from said debtor to said creditor made during a predetermined pre-preference period;
determine ordinary course parameters by analyzing said pre-preference period invoice payment data, wherein said ordinary course parameters comprise an invoice age range comprising an upper invoice age limit and a lower invoice age limit, said invoice age range determined by:
calculating a total representing a denominator sum of the amounts of said invoice payments at all invoice ages for a predetermined number of said payments made during said pre-preference period;
grouping one or more of said invoice ages into a plurality of invoice age increments and calculating a numerator sum of the amounts of said invoice payments at one or more of said invoice age increments;
dividing said numerator sum by said denominator so as to determine a percent of completion at one or more of said invoice age increments;
determining said upper invoice age limit by correlating a predetermined upper percent of completion limit with said percent of completion at one of said invoice age increments; and
determining said lower invoice age limit by correlating a predetermined lower percent of completion limit with said percent of completion at another one of said invoice age increments;
analyze said preference period invoice payment data to determine whether an invoice age of one or more of said payments made during said preference period is within or outside of said invoice age range, and wherein one or more of said invoice payments made during said preference period must have an invoice age outside said invoice age range to be considered to fall outside a universe of payments made in the ordinary course of business;
analyze said preference period invoice payment data in accordance with predetermined new value parameters to determine whether an amount of one or more or a portion of an amount of one or more invoice payments determined to fall outside of said universe of invoice payments made in the ordinary course of business was made in exchange for new value provided by said creditor to said debtor, wherein an amount of one or more of or a portion of an amount of said invoice payments falling outside said universe of invoice payments made in the ordinary course of business and determined not to be made in exchange for new value is determined to be a potentially voidable preference payment amount, and wherein said determination of said potentially voidable preference payment amount is determined by subtracting a total sum of new value from a total sum of the amount of said invoice payments falling outside said universe of invoice payments made in the ordinary course of business, wherein said total sum of new value is determined by:
calculating a daily sum of amounts of invoice payments for a day of said preference period;
calculating a daily sum of amounts invoiced for said day of said preference period;
calculating a total sum of amounts of invoice payments by adding together said daily sum of amounts of invoice payments for each day of said preference period up to and including said day;
calculating a total sum of new value by adding together a daily sum of new value for each day of said preference period up to and including one day before said day;
calculating said daily sum of new value, wherein said daily sum of new value is equal to:
said daily sum of amounts invoiced, if said daily sum of amount invoiced is less than a difference determined by subtracting said total sum of new value from said total sum of amounts of invoice payments, or said difference, if said daily sum of amounts invoiced is greater than said difference;
calculating said total sum of new value by adding together said daily sum of new value for each day of said preference period; and
create a record of said potentially voidable preference payment.
